(19) United States
(12) Patent Application Publication
(10) Pub. No.: US 2025/0372855 A1
(43) Pub. Date: Dec. 4, 2025

(54) WAVEGUIDE APPARATUS AND RELATED PRODUCT

(71) Applicant: Shenzhen Yinwang Intelligent Technologies Co., Ltd., Shenzhen (CN)

(72) Inventors: Zhongjie Wu, Shenzhen (CN); Haowei Li, Shenzhen (CN); Zhu Sun, Shenzhen (CN); Xiang Gao, Xi'an (CN); Xiaopan Yang, Xi'an (CN)

(73) Assignee: Shenzhen Yinwang Intelligent Technologies Co., Ltd., Shenzhen (CN)

(21) Appl. No.: 19/299,697

(22) Filed: Aug. 14, 2025

Related U.S. Application Data
(63) Continuation of application No. PCT/CN2023/076186, filed on Feb. 15, 2023.

(51) Int. Cl. H01P 3/12

(52) U.S. Cl. CPC H01P 3/12

(57) ABSTRACT

A waveguide apparatus and a related product are provided. The waveguide apparatus includes a first waveguide cavity, a first radiation port, and a second radiation port. A spacing between a radiation end of the first radiation port and a radiation end of the second radiation port is less than a spacing between a connection end of the first radiation port and a connection end of the second radiation port. The connection end of the first radiation port and the connection end of the second radiation port are both connected to the waveguide cavity.

### CROSS-REFERENCE TO RELATED APPLICATIONS

This application is a continuation of International Application No. PCT/CN2023/076186, filed on Feb. 15, 2023, the disclosure of which is hereby incorporated by reference in its entirety.

### TECHNICAL FIELD

This application relates to the field of millimeter-wave radar technologies, and in particular, to a waveguide apparatus and a related product.

### BACKGROUND

A waveguide is a structure used to directionally guide electromagnetic waves. The waveguide mainly serves as a transmission line for a microwave frequency, and is used to connect a microwave transmitter and a microwave receiver to their respective antennas in a microwave radio link device like a radar.

Compared with a conventional printed circuit board (PCB) printed antenna, a waveguide antenna has better radiation efficiency. A design of a parallel-fed waveguide antenna has been adopted in a current radar implementation, but the parallel-fed waveguide antenna has a complex three-dimensional structure, a high requirement for machining precision, and high machining costs.

### SUMMARY

Embodiments of this application provide a waveguide apparatus and a related product, to reduce complexity of a three-dimensional structure of a waveguide antenna, lower a requirement for machining precision, and reduce machining costs.

According to a first aspect, an embodiment of this application provides a waveguide apparatus. The waveguide apparatus includes: a first waveguide cavity, a first radiation port, and a second radiation port.

A signal in the first waveguide cavity is radiated through the first radiation port and the second radiation port.

A spacing between a radiation end of the first radiation port and a radiation end of the second radiation port is less than a spacing between a connection end of the first radiation port, and a connection end of the second radiation port. The connection end of the first radiation port and the connection end of the second radiation port are both connected to the first waveguide cavity.

In this embodiment of this application, in the waveguide apparatus, the spacing between the radiation end of the first radiation port and the radiation end of the second radiation port is a first spacing, and the spacing between the connection end of the first radiation port and the connection end of the second radiation port is a second spacing. The first spacing is set to be less than the second spacing, so that a grating lobe of the waveguide antenna can be suppressed, to reduce a sidelobe level of the waveguide antenna.

It may be understood that, in this embodiment of this application, the spacing between the first radiation port and the second radiation port gradually decreases in a direction in which the signal is radiated through the radiation port. A smaller spacing between the radiation ports can suppress the grating lobe of the waveguide antenna, to reduce the sidelobe level of the waveguide antenna.

According to some embodiments, the spacing between the radiation ends of the two radiation ports is set to be less than the spacing between the connection ends of the two radiation ports, so that a series-fed waveguide antenna with a low sidelobe level can be implemented. Compared with the current parallel-fed waveguide antenna, the waveguide apparatus in this embodiment of this application uses a series-fed waveguide in a simpler feeding form, so that complexity of a three-dimensional structure of the waveguide antenna can be reduced, a requirement for machining precision can be lowered, and machining costs can be reduced. In addition, a sidelobe level of the series-fed waveguide antenna is reduced, so that an advantage of the waveguide antenna in radiation transmission efficiency can be achieved.

In some embodiments, the first radiation port includes a first radiation sub-segment and a second radiation sub-segment that are connected, and the second radiation port includes a third radiation sub-segment and a fourth radiation sub-segment that are connected.

The first radiation sub-segment and the third radiation sub-segment are radiation segments close to the first waveguide cavity, and the second radiation sub-segment and the fourth radiation sub-segment are radiation segments away from the first waveguide cavity.

A spacing between the second radiation sub-segment and the fourth radiation sub-segment is less than a spacing between the first radiation sub-segment and the third radiation sub-segment.

In some embodiments, the first radiation port includes the first radiation sub-segment and the second radiation sub-segment that are connected, the second radiation port includes the third radiation sub-segment and the fourth radiation sub-segment that are connected, the first radiation sub-segment and the third radiation sub-segment are radiation segments close to the first waveguide cavity, the second radiation sub-segment and the fourth radiation sub-segment are radiation segments away from the first waveguide cavity, and the spacing between the second radiation sub-segment and the fourth radiation sub-segment is less than the spacing between the first radiation sub-segment and the third radiation sub-segment.

It may be understood that the radiation port in this embodiment of this application may include a plurality of (two or more) connected radiation sub-segments, and the plurality of connected radiation sub-segments meet the following condition: A spacing between radiation sub-segments that are of two radiation ports and that are away from the waveguide cavity is less than a spacing between radiation sub-segments that are of the two radiation ports and that are close to the waveguide cavity.

In this embodiment of this application, the spacing between the radiation ports decreases in the direction in which the signal is radiated, so that the grating lobe of the waveguide antenna can be suppressed, to reduce the sidelobe level of the waveguide antenna, and implement the series-fed waveguide antenna with the low sidelobe level. This can reduce complexity of the three-dimensional structure of the waveguide antenna, lower the requirement for machining precision, and reduce the machining costs.

In some embodiments, the waveguide apparatus further includes: a third radiation port.

The first radiation port is located between the second radiation port and the third radiation port.

The signal in the first waveguide cavity is further radiated through the third radiation port.

A spacing between a radiation end of the third radiation port and the radiation end of the first radiation port is less than or equal to a spacing between a connection end of the third radiation port and the connection end of the first radiation port, The connection end of the first radiation port and the connection end of the third radiation port are both connected to the waveguide cavity. Alternatively, a spacing between a radiation end of the third radiation port and the radiation end of the first radiation port is greater than a spacing between the connection end of the third radiation port and the connection end of the first radiation port.

In some embodiments, the waveguide apparatus further includes the third radiation port. The first radiation port is located between the second radiation port and the third radiation port. The first radiation port and the second radiation port are distributed closer to a center of a narrow side wall of the first waveguide cavity than the third radiation port. A spacing between a radiation end of the third radiation port and the radiation end of the first radiation port is a third spacing, and a spacing between a connection end of the third radiation port and the connection end, of the first radiation port is a fourth spacing. In this case, regardless of whether the third spacing is less than, equal to, or greater than the fourth spacing, the grating lobe of the waveguide antenna can be suppressed to some extent, to reduce the sidelobe level of the waveguide antenna.

It may be understood that, in this embodiment of this application, regardless of whether the spacing between the third radiation port and the first radiation port gradually decreases, remains unchanged, or increases in a direction in which the signal is radiated through the radiation port, the grating lobe of the waveguide antenna can be suppressed to some extent, to reduce the sidelobe level of the waveguide antenna.

It may be understood that an effect of suppressing the grating lobe of the waveguide antenna in a case in which the third spacing is less than the fourth spacing is better than an effect of suppressing the grating lobe of the waveguide antenna in a case in which the third spacing is greater than the fourth spacing, so that an effect of reducing the sidelobe level of the waveguide antenna is better. To be specific, an effect of suppressing the grating lobe of the waveguide antenna in a case in which the third spacing gradually decreases in the direction in which the signal is radiated through the radiation port is better than an effect of suppressing the grating lobe of the waveguide antenna in a case in which the fourth spacing gradually increases in the direction in which the signal is radiated through the radiation port, so that the effect of reducing the sidelobe level of the waveguide antenna is better.

In some embodiments, the third radiation port includes a fifth radiation sub-segment and a sixth radiation sub-segment that are connected.

The fifth radiation sub-segment is a radiation segment close to the first waveguide cavity, and the sixth radiation sub-segment is a radiation segment away from the first waveguide cavity.

A spacing between the sixth radiation sub-segment and the second radiation sub-segment is less than or equal to a spacing between the fifth radiation sub-segment and the first radiation sub-segment; or a spacing between the sixth radiation sub-segment and the second radiation sub-segment is greater than a spacing between the fifth radiation sub-segment and the first radiation sub-segment.

In some embodiments, the third radiation port includes the fifth radiation sub-segment and the sixth radiation sub-segment that are connected, the fifth radiation sub-segment is a radiation segment close to the first waveguide cavity, the sixth radiation sub-segment is a radiation segment away from the first waveguide cavity, and the spacing between the sixth radiation sub-segment and the second radiation sub-segment may be less than, equal to, or greater than the spacing between the fifth radiation sub-segment and the first radiation sub-segment. In this case, the grating lobe of the waveguide antenna can be suppressed, to reduce the sidelobe level of the waveguide antenna.

It may be understood that the third radiation port and the first radiation port in this embodiment of this application may include a plurality of (two or more) connected radiation sub-segments, and the plurality of connected radiation sub-segments need to meet the following condition: A spacing between radiation sub-segments that are of the third radiation port and the first radiation port and that are away from the waveguide cavity may be less than or equal to a spacing between radiation sub-segments that are of the two radiation ports and that are close to the waveguide cavity.

It may be understood that an effect of suppressing the grating lobe of the waveguide antenna in a case in which the spacing between the radiation sub-segments that are of the third radiation port and the first radiation port and that are away from the waveguide cavity is less than the spacing between the radiation sub-segments that are of the two radiation ports and that are close to the waveguide cavity, is better than an effect of suppressing the grating lobe of the waveguide antenna in a case in which the spacing between the radiation sub-segments that are of the third radiation port and the first radiation port and that are away from the waveguide cavity is greater than the spacing between the radiation sub-segments that are of the two radiation ports and that are close to the waveguide cavity.

In some embodiments, the spacing between the second radiation sub-segment and the fourth radiation sub-segment is less than the spacing between the second radiation sub-segment and the sixth radiation sub-segment.

In some embodiments, the spacing between the second radiation sub-segment and the fourth radiation sub-segment is less than the spacing between the second radiation sub-segment and the sixth radiation sub-segment. The first radiation port and the second radiation port are distributed on the narrow side wall of the first waveguide cavity, and is closer to the center of the narrow side wall of the first waveguide cavity than the third radiation port that is also located on the narrow side wall of the first waveguide cavity. Therefore, in this embodiment of this application, the spacing between the second radiation sub-segment and the fourth radiation sub-segment is set to be less than the spacing between the second radiation sub-segment and the sixth radiation sub-segment, so that the grating lobe of the waveguide antenna can be suppressed, to reduce the sidelobe level of the waveguide antenna.

In some embodiments, the spacing s1 between the second radiation sub-segment and the fourth radiation sub-segment meets the following condition:

$$0.35 {λ}_{0} \leq s 1 \leq 0.6 {λ}_{0} ,$$

where
λ₀ indicates a wavelength of an electromagnetic wave in vacuum.

In some embodiments, the spacing s1 between the second radiation sub-segment and the fourth radiation sub-segment meets the foregoing condition, so that the grating lobe of the waveguide antenna can be suppressed, to reduce the sidelobe level of the waveguide antenna.

In some embodiments, the spacing s2 between the first radiation sub-segment and the third radiation sub-segment meets the following condition:

$$0.4 {λ}_{g} \leq s 2 \leq 0.6 {λ}_{g} ,$$

λ_{g} indicates a wavelength of an electromagnetic wave transmitted in the first waveguide cavity.

In some embodiments, the spacing s2 between the first radiation sub-segment and the third radiation sub-segment meets the foregoing condition, so that the grating lobe of the waveguide antenna can be suppressed, to reduce the sidelobe level of the waveguide antenna.

In some embodiments, that the signal in the first waveguide cavity is radiated through the first radiation port and the second radiation port includes: the signal in the first waveguide cavity is radiated from the first radiation port and the second radiation port in a first direction through a first surface of the first waveguide cavity; and a width of the first surface in a second direction is the same as a width of the radiation port, a length of the first surface in a third direction is the same as a length of the first waveguide cavity, and the first direction, the second direction, and the third direction are perpendicular to each other.

In some embodiments, the first radiation port and the second radiation port are distributed on the narrow side wall of the first waveguide cavity (namely, the first surface of the first waveguide cavity). In this case, the signal in the first waveguide cavity is radiated from the first radiation port and the second radiation port in the first direction through the first surface of the first waveguide cavity. In addition, the width of the first surface in the second direction is the same as the width of the radiation port, the length of the first surface in the third direction is the same as the length of the first waveguide cavity, and the first direction, the second direction, and the third direction are perpendicular to each other. It may be understood that the first direction, the second direction, and the third direction are perpendicular to each other to form a three-dimensional space. In this embodiment of this application, the first radiation port and the second radiation port are distributed on the narrow side wall of the first waveguide cavity, and the signal in the first waveguide cavity is radiated from the first radiation port and the second radiation port in the first direction through the narrow side wall of the first waveguide cavity, so that signal radiation efficiency can be improved.

In some embodiments, three-dimensional dimensions L1, a1, and b1 of the first waveguide cavity meet the following conditions:

$$0.85 \times ( N \times {λ}_{g} / 2 ) \leq L 1 \leq 1.15 \times ( N \times \frac{{λ}_{g}}{2} ) , 0 < a 1 \leq 0.5 {λ}_{g} , and 0.5 {λ}_{g} \leq b 1 \leq {λ}_{g} ,$$

where λ_{g} indicates the wavelength of the electromagnetic wave transmitted in the first waveguide cavity, and N indicates a quantity of radiation ports; and L1 indicates the length of the first waveguide cavity in the third direction, a1 indicates a width of the first waveguide cavity in the second direction, and b1 indicates a height of the first waveguide cavity in the first direction.

In some embodiments, the length of the first waveguide cavity in the third direction is L1, the width of the first waveguide cavity in the second direction is a1, the height of the first waveguide cavity in the first direction is b1, and the three-dimensional dimensions L1, a1, and b1 of the first waveguide cavity meet the foregoing condition. In this way, steady-state field distribution in the first waveguide cavity can be implemented, and transmission efficiency of the signal in the first waveguide cavity can be improved.

In some embodiments, a spacing d1 between two first waveguide cavities in the waveguide apparatus meets the following condition:

$$0.5 {λ}_{0} \leq d 1 \leq 1.5 {λ}_{0} ,$$

where λ₀ indicates the wavelength of the electromagnetic wave in vacuum.

In some embodiments, the spacing d1 between the two (or more) first waveguide cavities in the waveguide apparatus meets the foregoing condition, so that a feed network can be simplified, and a waveguide antenna array can be arranged at a small spacing. This reduces complexity of the three-dimensional structure of the waveguide antenna, lowers the requirement for machining precision, and reduces the machining costs.

In some embodiments, the first waveguide cavity has a bent structure, and the bent structure is used to connect the first radiation port to the second radiation port.

In some embodiments, the first waveguide cavity includes the bent structure, and the bent structure is used to connect the first radiation port to the second radiation port. The bent structure may be a straight-line bent structure or a curve bent structure (for example, including but not limited to a triangular waveform, a sine waveform, and a cosine waveform). This is not limited in embodiments of this application. In this embodiment of this application, after a straight waveguide is reconstructed into a waveguide having a bent structure, radiation ports are designed on a narrow side wall, so that a spatial distance between the radiation ports can be reduced within an entire waveguide wavelength, and the grating lobe of the waveguide antenna can be suppressed, to reduce the sidelobe level of the waveguide antenna and achieve an advantage of the waveguide antenna in radiation transmission efficiency.

In some embodiments, cross-sectional dimensions x1 and y1 of the bent structure in the first direction meet the following conditions:

$$0.15 {λ}_{g} \leq x 1 \leq 0.35 {λ}_{g} and 0.65 {λ}_{g} \leq y 1 \leq 0.85 {λ}_{g} ,$$

where x1 indicates a length of the bent structure in the second direction, and y1 indicates a length of the bent structure in the third direction.

In some embodiments, the length of the bent structure in the second direction is x1, the length of the bent structure in the third direction is y1, and the cross-sectional dimensions x1 and y1 of the bent structure in the first direction meet the foregoing condition. In this way, a spatial distance between radiation ports can be reduced within an entire waveguide wavelength, and the grating lobe of the waveguide antenna can be suppressed, to reduce the sidelobe level of the waveguide antenna and achieve an advantage of the waveguide antenna in radiation transmission efficiency.

In some embodiments, a pattern sidelobe level corresponding to the waveguide apparatus is less than a first threshold.

In some embodiments, the spacing between the radiation ends of the two radiation ports is set to be less than the spacing between the connection ends, of the two radiation ports, connected to the waveguide cavity, so that the series-fed waveguide antenna with the low sidelobe level can be implemented; and the pattern sidelobe level corresponding to the waveguide apparatus is less than the first threshold, so that an anti-interference capability of the waveguide antenna is improved. Therefore, the series-fed waveguide in a simpler feeding form can reduce complexity of the three-dimensional structure of the waveguide antenna, lower the requirement for machining precision, and reduce the machining costs; and the sidelobe level of the series-fed waveguide antenna is reduced, so that the advantage of the waveguide antenna in radiation transmission efficiency can be achieved.

It may be understood that the first threshold in this embodiment of this application is not a fixed value, and may be adjusted based on different application scenarios. For example, compared with a conventional PCB printed antenna, the waveguide apparatus in this embodiment of this application has a great advantage in radiation efficiency. In this case, the first threshold may be adjusted, so that the pattern sidelobe level corresponding to the waveguide apparatus is less than a pattern sidelobe level corresponding to the conventional PCB printed antenna.

According to a second aspect, an embodiment of this application provides a waveguide apparatus. The waveguide apparatus includes: a second waveguide cavity and M radiation ports, where M is an integer greater than 1; a signal in the second waveguide cavity is radiated through the M radiation ports; and the second waveguide cavity has a bent structure, and the bent structure is used to connect to the M radiation ports.

In this embodiment of this application, the second waveguide cavity in the waveguide apparatus has the bent structure, the bent structure is used to connect to the M radiation ports, and the signal in the second waveguide cavity is radiated through the M radiation ports. The bent structure may be a straight-line bent structure or a curve bent structure (for example, including but not limited to a triangular waveform, a sine waveform, and a cosine waveform). This is not limited in embodiments of this application.

It may be understood that, in this embodiment of this application, the bent structure used to connect to the M radiation ports can reduce a spatial distance between the radiation ports within an entire waveguide wavelength, and suppress a grating lobe of the waveguide antenna, to reduce a sidelobe level of the waveguide antenna.

In some embodiments, after a straight waveguide is reconstructed into a waveguide having a bent structure, radiation ports are designed on a narrow side wall, so that a spatial distance between the radiation ports can be reduced within an entire waveguide wavelength, and the grating lobe of the waveguide antenna can be suppressed, to reduce the sidelobe level of the waveguide antenna and achieve an advantage of the waveguide antenna in radiation transmission efficiency. Therefore, a series-fed waveguide antenna with a low sidelobe level is implemented. Compared with the current parallel-fed waveguide antenna, the waveguide apparatus in this embodiment of this application uses a series-fed waveguide in a simpler feeding form, so that complexity of a three-dimensional structure of the waveguide antenna can be reduced, a requirement for machining precision can be lowered, and machining costs can be reduced. In addition, a sidelobe level of the series-fed waveguide antenna is reduced, so that an advantage of the waveguide antenna in radiation transmission efficiency can be achieved.

In some embodiments, that the signal in the second waveguide cavity is radiated through the M radiation ports includes: the signal in the second waveguide cavity is radiated from the M radiation ports in a first direction through a first surface of the second waveguide cavity; and a width of the first surface in a second direction is the same as a width of the radiation port, a length of the first surface in a third direction is the same as a length of the second waveguide cavity, and the first direction, the second direction, and the third direction are perpendicular to each other.

In some embodiments, the M radiation ports are distributed on a narrow side wall of the second waveguide cavity (namely, the first surface of the second waveguide cavity). In this case, the signal in the second waveguide cavity is radiated from the M radiation ports in the first direction through the first surface of the second waveguide cavity. In addition, the width of the first surface in the second direction is the same as the width of the radiation port, the length of the first surface in the third direction is the same as the length of the second waveguide cavity, and the first direction, the second direction, and the third direction are perpendicular to each other. It may be understood that the first direction, the second direction, and the third direction are perpendicular to each other to form a three-dimensional space. In this embodiment of this application, the M radiation ports are distributed on the narrow side wall of the second waveguide cavity, and the signal in the second waveguide cavity is radiated from the M radiation ports in the first direction through the narrow side wall of the second waveguide cavity, so that signal radiation efficiency can be improved.

In some embodiments, cross-sectional dimensions x2 and y2 of the bent structure in the first direction meet the following conditions:

$$0.15 {λ}_{g} \leq x 2 \leq 0.35 {λ}_{g} and 0.65 {λ}_{g} \leq y 2 \leq 0.85 {λ}_{g} ,$$

where x2 indicates a length of the bent structure in the second direction, and y2 indicates a length of the bent structure in the third direction.

In some embodiments, the length of the bent structure in the second direction is x2, the length of the bent structure in the third direction is y2, and the cross-sectional dimensions x2 and y2 of the bent structure in the first direction meet the foregoing condition. In this way, a spatial distance between radiation ports can be reduced within an entire waveguide wavelength, and the grating lobe of the waveguide antenna can be suppressed, to reduce the sidelobe level of the waveguide antenna and achieve an advantage of the waveguide antenna in radiation transmission efficiency.

In some embodiments, three-dimensional dimensions L2, a2, and b2 of the second waveguide cavity meet the following conditions:

$$0.85 \times ( M \times {λ}_{g} / 2 ) \leq L 2 \leq 1.15 \times ( M \times \frac{{λ}_{g}}{2} ) , 0 < a 2 \leq 0.5 {λ}_{g} , and$$

$$0.5 {λ}_{g} \leq b 2 \leq {λ}_{g} ,$$

where λ_{g} indicates a wavelength of an electromagnetic wave transmitted in the second waveguide cavity; and L2 indicates the length of the second waveguide cavity in the third direction, a2 indicates a width of the second waveguide cavity in the second direction, and b2 indicates a height of the second waveguide cavity in the first direction.

In some embodiments, the length of the second waveguide cavity in the third direction is L2, the width of the second waveguide cavity in the second direction is a2, the height of the second waveguide cavity in the first direction is b2, and the three-dimensional dimensions L2, a2, and b2 of the second waveguide cavity meet the foregoing condition. In this way, steady-state field distribution in the second waveguide cavity can be implemented, and transmission efficiency of the signal in the second waveguide cavity can be improved.

In some embodiments, a spacing d2 between two second waveguide cavities in the waveguide apparatus meets the following condition:

$$0.5 {λ}_{0} \leq d 2 \leq 1.5 {λ}_{0} ,$$

where λ₀ indicates a wavelength of an electromagnetic wave in vacuum.

In some embodiments, the spacing d2 between the two (or more) second waveguide cavities in the waveguide apparatus meets the foregoing condition, so that a feed network can be simplified, and a waveguide antenna array can be arranged at a small spacing. This reduces complexity of the three-dimensional structure of the waveguide antenna, lowers the requirement for machining precision, and reduces the machining costs.

In some embodiments, a spacing s3 between two adjacent radiation ports in the M radiation ports meets the following condition:

$$0.35 {λ}_{0} \leq s 3 \leq 0.6 {λ}_{0} ,$$

where λ₀ indicates the wavelength of the electromagnetic wave in vacuum.

In some embodiments, the spacing s3 between the two adjacent radiation ports in the M radiation ports meets the foregoing condition, so that the grating lobe of the waveguide antenna can be suppressed, to reduce the sidelobe level of the waveguide antenna.

In some embodiments, a pattern sidelobe level corresponding to the waveguide apparatus is less than a second threshold.

In some embodiments, after the straight waveguide is reconstructed into the waveguide having the bent structure, radiation ports are designed on the narrow side wall, so that the series-fed waveguide antenna with the low sidelobe level can be implemented; and the pattern sidelobe level corresponding to the waveguide apparatus is less than the second threshold, so that an anti-interference capability of the waveguide antenna is improved. Therefore, the series-fed waveguide in a simpler feeding form can reduce complexity of the three-dimensional structure of the waveguide antenna, lower the requirement for machining precision, and reduce the machining costs; and the sidelobe level of the series-fed waveguide antenna is reduced, so that the advantage of the waveguide antenna in radiation transmission efficiency can be achieved.

It may be understood that the second threshold in this embodiment of this application is not a fixed value, and may be adjusted based on different application scenarios. For example, compared with a conventional PCB printed antenna, the waveguide apparatus in this embodiment of this application has a great advantage in radiation efficiency. In this case, the second threshold may be adjusted, so that the pattern sidelobe level corresponding to the waveguide apparatus is less than a pattern sidelobe level corresponding to the conventional PCB printed antenna.

According to a third aspect, an embodiment of this application provides a radar or a radar system. The radar or the radar system includes the waveguide apparatus according to the first aspect or includes the waveguide apparatus according to the second aspect. It should be noted that there may be a smart sensor that is integrated with a plurality of sensors. When the smart sensor includes a millimeter-wave detection function, the smart sensor may also be referred to as a millimeter-wave radar or a millimeter-wave radar system.

According to a fourth aspect, an embodiment of this application provides a terminal device. The terminal device includes the waveguide apparatus according to the first aspect or any one of the possible implementations of the first aspect, or includes the waveguide apparatus according to the second aspect or any one of the possible implementations of the second aspect, or includes the radar or the radar system according to the third aspect.

According to a fifth aspect, an embodiment of this application provides a vehicle. The vehicle includes the waveguide apparatus according to the first aspect or the second aspect, the radar or the radar system according to the third aspect, or the terminal device according to the fourth aspect.

In embodiments of this application, a series-fed waveguide in a simpler feeding form is used, so that complexity of a three-dimensional structure of a waveguide antenna can be reduced, a requirement for machining precision can be lowered, and machining costs can be reduced. In addition, a sidelobe level of a series-fed waveguide antenna is reduced, so that an advantage of the waveguide antenna in radiation transmission efficiency can be achieved.

### BRIEF DESCRIPTION OF DRAWINGS

FIG. 1 is a diagram of radar distribution according to an embodiment of this application;

FIG. 2 is a diagram of an architecture of a radar according to an embodiment of this application;

FIG. 3 is a diagram of a structure of a waveguide antenna feed network according to an embodiment of this application;

FIG. 4 is a diagram of a structure of a waveguide antenna feed network according to an embodiment of this application;

FIG. 5 is a diagram of a structure of a waveguide apparatus according to an embodiment of this application;

FIG. 6 is a plane diagram of a waveguide apparatus according to an embodiment of this application;

FIG. 7 is a plane diagram of a waveguide apparatus according to an embodiment of this application;

FIG. 8A is a plane diagram of a waveguide apparatus according to an embodiment of this application;

FIG. 8B is a plane diagram of a waveguide apparatus according to an embodiment of this application;

FIG. 8C is a plane diagram of a waveguide apparatus according to an embodiment of this application;

FIG. 8D is a plane diagram of a waveguide apparatus according to an embodiment of this application;

FIG. 9A is a plane diagram of a waveguide apparatus according to an embodiment of this application;

FIG. 9B is a plane diagram of a waveguide apparatus according to an embodiment of this application;

FIG. 10A is a diagram of signal distribution of a waveguide apparatus according to an embodiment of this application;

FIG. 10B is a diagram of an effect of a radiation pattern according to an embodiment of this application;

FIG. 11A is a diagram of signal distribution of a waveguide apparatus according to an embodiment of this application;

FIG. 11B is a diagram of an effect of a radiation pattern according to an embodiment of this application;

FIG. 12 is a diagram of a structure of another waveguide apparatus according to an embodiment of this application;

FIG. 13 is a plane diagram of a waveguide apparatus according to an embodiment of this application;

FIG. 14A is a plane diagram of a waveguide apparatus according to an embodiment of this application;

FIG. 14B is a plane diagram of a waveguide apparatus according to an embodiment of this application;

FIG. 14C is a plane diagram of a waveguide apparatus according to an embodiment of this application;

FIG. 14D is a plane diagram of a waveguide apparatus according to an embodiment of this application;

FIG. 15A is a diagram of signal distribution of a waveguide apparatus according to an embodiment of this application;

FIG. 15B is a diagram of an effect of a radiation pattern according to an embodiment of this application;

FIG. 16 is a diagram of a waveguide antenna feed network according to an embodiment of this application;

FIG. 17A is a diagram of an effect of a return loss according to an embodiment of this application; and

FIG. 17B is a diagram of an effect of transmission isolation according to an embodiment of this application.

### DETAILED DESCRIPTION

The terms “first”, “second”, and the like in the specification, claims, and accompanying drawings of this application are used to distinguish between different objects, but are not used to describe a specific sequence. In addition, the terms such as “include” and “have” and any other variants thereof are intended to cover a non-exclusive inclusion. For example, processes, methods, systems, products, or devices that include a series of steps or units are not limited to enumerated steps or units, but instead, optionally further include steps or units that are not enumerated, or optionally further include other steps or units inherent to these processes, methods, products, or devices.

“Embodiments” mentioned herein mean that specific features, structures, or characteristics described in combination with the embodiments may be included in at least one embodiment of this application. The phrase shown in various locations in the specification may not necessarily refer to a same embodiment, and is not an independent or optional embodiment exclusive from another embodiment. It may be understood explicitly and implicitly by a person skilled in the art that the embodiments described herein may be combined with other embodiments.

It should be understood that, in this application, “at least one (item)” means one or more, “a plurality of” means two or more, “at least two (items)” means two, three, or more, and “and/or” is used to describe an association relationship between associated objects, and indicates that there may be three relationships. For example, “A and/or B” may indicate that only A exists, only B exists, and both A and B exist, where A and B may be singular or plural. The character “/” generally indicates an “or” relationship between the associated objects. “At least one of the following items (pieces)” or a similar expression thereof means any combination of these items, including a single item (piece) or any combination of a plurality of items (pieces). For example, at least one item (piece) of a, b, or c may indicate a, b, c, a and b, a and c, b and c, or a, b, and c, where a, b, and c may be singular or plural.

As described in the background, currently, how to resolve problems of a complex three-dimensional structure and high machining costs of a waveguide antenna needs to be studied. This application provides a waveguide apparatus and a related product, and relates to the field of millimeter-wave radar technologies. A series-fed waveguide in a simpler feeding form is used, so that complexity of a three-dimensional structure of a waveguide antenna can be reduced, a requirement for machining precision can be lowered, and machining costs can be reduced. In addition, a sidelobe level of a series-fed waveguide antenna is reduced, so that an advantage of the waveguide antenna in radiation transmission efficiency can be achieved.

The following describes, with reference to the accompanying drawings in embodiments of this application, a signal processing system provided in embodiments of this application.

Radar is short for radio detection and ranging. The radar is used to discover a target and determine a spatial location of the target by using a radio method.

A detection medium of the radar is an electromagnetic wave, and the radar implements detection of a target, for example, distance measurement, speed measurement, or azimuth measurement, through transmission and reception of the electromagnetic wave. The radar can implement distance detection on the target based on time of flight of the electromagnetic wave. The time of flight is a time difference between receiving and transmission of the electromagnetic wave. The radar transmits an electromagnetic wave signal, receives an echo signal of the electromagnetic wave signal, and may implement distance detection on the target based on a time difference between the received echo signal and the transmitted electromagnetic wave signal and a propagation speed of the electromagnetic wave. A distance between the radar and the target may be determined according to the following formula: s=c*t/2, where s indicates the distance of the target, t indicates the time of flight, namely, a time period from transmission of the electromagnetic wave signal from the radar to receiving of the echo signal, and c indicates the speed of light.

The radar implements speed measurement on the target based on a Doppler effect (Doppler effect). A principle of the Doppler effect is as follows: When a vibration source like a sound, light, and a radio wave moves relative to an observer at a relative speed, a frequency of vibration received by the observer is different from a frequency generated by the vibration source. When the electromagnetic wave transmitted by the radar moves relative to a detected object, a frequency of the echo signal is different from a frequency of the transmitted electromagnetic wave signal. When the target approaches an antenna of the radar, the frequency of the echo signal is higher than the frequency of the transmitted electromagnetic wave signal. When the target moves away from the antenna of the radar, the frequency of the echo signal is lower than the frequency of the transmitted electromagnetic wave signal. A frequency change caused by the Doppler effect is referred to as a Doppler frequency shift, which is proportional to the relative speed and inversely proportional to the vibration frequency. Therefore, a frequency difference between the transmitted electromagnetic wave signal and the echo signal is detected, so that a moving speed of the target relative to the radar, namely, the relative speed of the target relative to the radar, can be measured.

The radar may measure an azimuth by using an amplitude method, a phase method, or the like. The amplitude method is used to measure an azimuth by using an amplitude value of an echo signal received through an antenna, and a change rule of the amplitude value depends on an antenna pattern and a scanning manner of the antenna. The phase method is used to measure an azimuth by using a phase difference between echo signals received through a plurality of antenna elements. For example, the radar receives, by using an antenna array, echo signals reflected by a same target, and calculates an azimuth of the target based on a phase difference of the echo signals.

A detection medium of a millimeter-wave radar is an electromagnetic wave within a specific wavelength range, for example, a microwave. Currently, a millimeter wave and a centimeter wave (for example, a centimeter wave in a 24 giga-hertz (GHz) frequency band) adjacent to the millimeter wave in wave bands are commonly used. The millimeter wave is an electromagnetic wave with a wavelength of 1 to 10 millimeters (mm), and a wavelength of an electromagnetic wave in the 24 GHz frequency band is slightly greater than 10 mm. Because a wavelength of the detection medium of the millimeter-wave radar is in an overlapped wavelength range of the microwave and a far infrared wave, the detection medium of the millimeter-wave radar has characteristics of two spectrums. According to a wave propagation theory, a higher frequency indicates a shorter wavelength, a higher resolution, and a stronger penetration capability, while in this case, a loss in a propagation process is larger, and a transmission distance is shorter. On the contrary, a lower the frequency indicates a longer wavelength, a stronger diffraction capability, and a longer transmission distance. Therefore, compared with the microwave, the detection medium of the millimeter-wave radar has a high resolution, good directivity, a strong anti-interference capability, and good detection performance. Compared with infrared, the detection media of the millimeter-wave radar has lower atmospheric attenuation, better penetration to smoke and dust, and is less affected by weather. Therefore, the millimeter-wave radar is increasingly widely used in a plurality of fields such as intelligent vehicles, drones, intelligent transportation, and industrial automation.

Based on a detection distance, the radar can be classified into a long-distance radar (LRR), a medium-range radar (MRR), and a short-range radar (SRR). The LRR has a high requirement for a detection distance, and has a low requirement for a width of a detection angular domain. The SRR has a low requirement for a detection distance, and has a high requirement for a width of a detection angular domain. A requirement of the MRR on a detection distance and a width of an angular domain may be understood as being between that of the LRR and that of the SRR. For example, the detection distance of the LRR may be greater than 200 meters, and the width of the angular domain may be ±15°; the detection distance of the MRR may be within 100 meters, and the width of the angular domain may be ±45°; and the detection distance of the SRR may be within 60 meters, and the width of the angular domain may be #80°. During use, different types of radars may be mounted at different locations of a vehicle body based on a function requirement of autonomous driving and a use status of another sensor. A quantity and types of the radars may be selected based on a requirement.

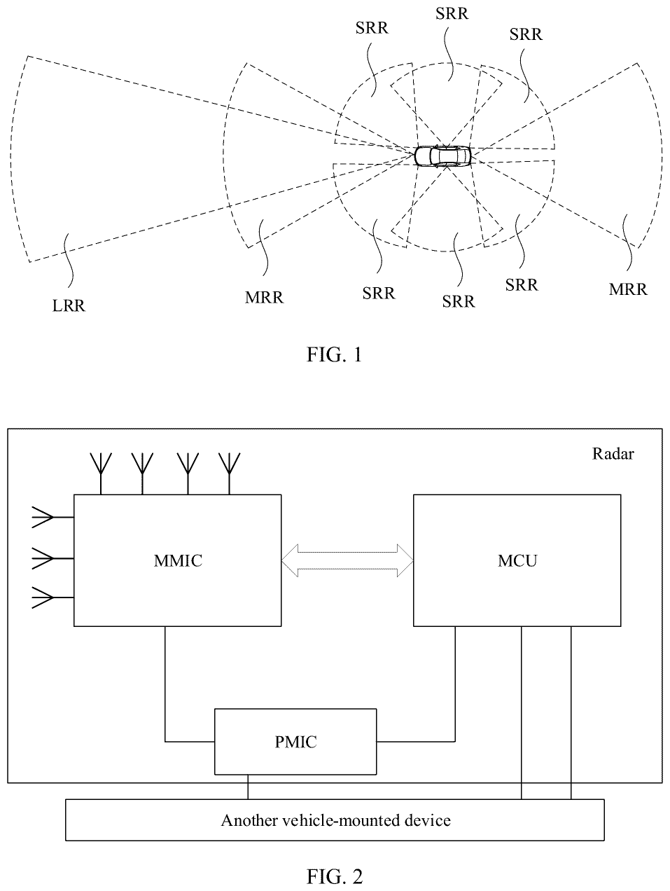

FIG. 1 is a diagram of radar distribution according to an embodiment of this application.

FIG. 1 shows possible mounting locations of several types of radars. The mounting locations are merely examples; and during actual use, more or fewer radars may be selected, and the types may also be adjusted.

As shown in FIG. 1, an LRR may be mounted on the front of a vehicle body and serve as a forward radar; an MRR may be mounted on the front or the rear of the vehicle body and serve as a forward radar or a backward radar; and an SRR may be mounted on a side of the vehicle body or four corners of the vehicle body and serve as a side radar or a corner radar. In addition, the MRR may alternatively be mounted on a side of the vehicle body or the four corners of the vehicle body, and the SRR may alternatively be mounted on the front or the rear of the vehicle body.

The radar may be classified based on a modulation manner (or a radiation manner) of an electromagnetic wave of the radar. The modulation manner of the electromagnetic wave of the radar includes a pulse manner and a continuous wave manner. Therefore, the radar may be classified into a pulse radar and a continuous wave radar. The continuous wave manner may be further classified into frequency shift keying (FSK), phase shift keying (PSK), a constant-frequency/single-frequency continuous wave (CW), a frequency modulated continuous wave (FMCW), multiple frequency shift keying (MFSK), a phase modulated continuous wave (PMCW), and the like. Featuring in multi-target detection, a high resolution, and low costs, the FMCW manner has become a mainstream radar modulation manner.

FIG. 2 is a diagram of an architecture of a radar according to an embodiment of this application.

As shown in FIG. 2, the radar includes a monolithic microwave integrated circuit (MMIC), a microcontroller unit (MCU), and a power management integrated circuit (PMIC). The MMIC may integrate a function of a radio frequency part. The MCU may integrate a function of a baseband part, for example, integrate a function of a signal processor. In addition, the MCU may provide a communication interface for communicating with another vehicle-mounted device. The PMIC is a chip that supplies power to a hardware system of the radar.

A waveguide is a structure used to directionally guide electromagnetic waves. In electromagnetics and communication engineering, the waveguide may be any linear structure in which electromagnetic waves are transmitted between endpoints of the waveguide. The waveguide mainly serves as a transmission line for a microwave frequency, and is used to connect a microwave transmitter and a microwave receiver to respective antennas in a radar, a communication satellite, and a microwave radio link device.

At present, with development of system functions, millimeter-wave vehicle radar antennas are required to achieve higher efficiency and wider frequency band. Compared with a conventional printed circuit board (PCB) printed antenna, a waveguide antenna has great advantages in radiation transmission efficiency and wideband characteristics. However, complexity of a three-dimensional structure of a waveguide antenna feed network limits its application in a millimeter wave radar in terms of a size and manufacturing cost. Therefore, if a structure of the waveguide antenna can be simplified without compromising performance of the antenna, application of the waveguide antenna in the millimeter wave radar will be substantially enhanced.

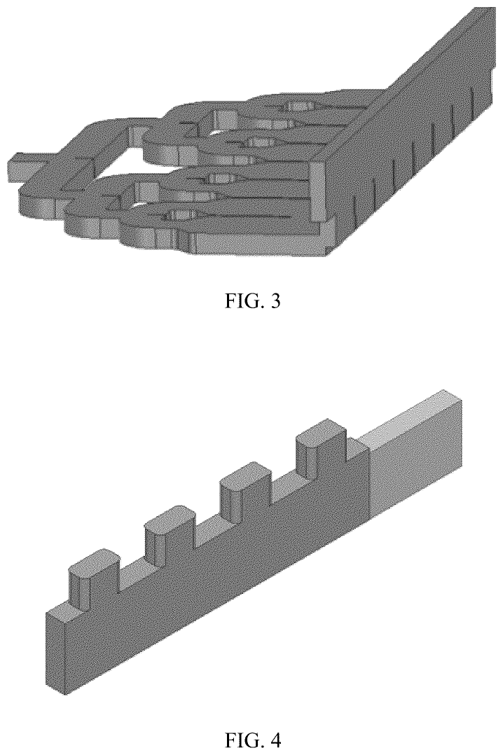

FIG. 3 is a diagram of a structure of a waveguide antenna feed network according to an embodiment of this application.

FIG. 3 shows the waveguide antenna feed network implemented by using a multi-stage T-type power divider. Specifically, a multi-stage parallel H-T power divider is used to implement one-to-eight power dividing feeding, and amplitude-phase weighting of a radiation port is implemented by using a bias feeding design at a last-stage power divider, to reduce a V-plane pattern sidelobe level.

A processing technology for preparing the waveguide antenna feed network is to implement processing in a four-layer splitting manner. Each layer of mechanical part obtained through splitting is processed and formed by using a plastic mold, then surface metallization is implemented by using a surface electroplating process, and finally a structure of the waveguide antenna feed network is obtained by using an inter-layer brazing process.

It can be learned from FIG. 3 that the waveguide antenna feed network has a complex three-dimensional structure, a high requirement for machining precision, and high machining costs. In addition, in this embodiment of this application, only eight radiation ports are used as an example for description. As a quantity of radiation ports increases, more levels of T-type power dividers need to be used in the waveguide antenna feed network. This causes a larger profile height of the waveguide antenna feed network, making the three-dimensional structure of the waveguide antenna feed network complex. In addition, multi-layer processing has a high requirement for machining precision, resulting in a decrease in performance tolerance capability and high machining costs.

FIG. 4 is a diagram of a structure of a waveguide antenna feed network according to an embodiment of this application.

FIG. 4 shows a waveguide antenna feed network implemented by using a series-fed waveguide antenna in a simpler feeding form. Compared with the parallel-fed waveguide antenna shown in FIG. 3, the series-fed waveguide antenna in this embodiment of this application can significantly simplify complexity of a three-dimensional structure of the waveguide antenna feed network, lower a requirement for machining precision, and reduce machining costs.

However, a sidelobe level of the series-fed waveguide antenna in a simpler feeding form is high, resulting in low signal radiation transmission efficiency.

To resolve the problems that the complex three-dimensional structure of the waveguide antenna feed network results in high machining costs and the high sidelobe level results in low signal radiation transmission efficiency, in embodiments of this application, a radar waveguide antenna feed network that can operate in a millimeter wave band of 76 GHz to 78 GHz is designed, to achieve an advantage of the waveguide antenna in radiation transmission efficiency, and resolve a problem that a current waveguide antenna has a complex three-dimensional structure and high machining costs.

The following describes, with reference to the accompanying drawings in embodiments of this application, a waveguide apparatus provided in embodiments of this application.

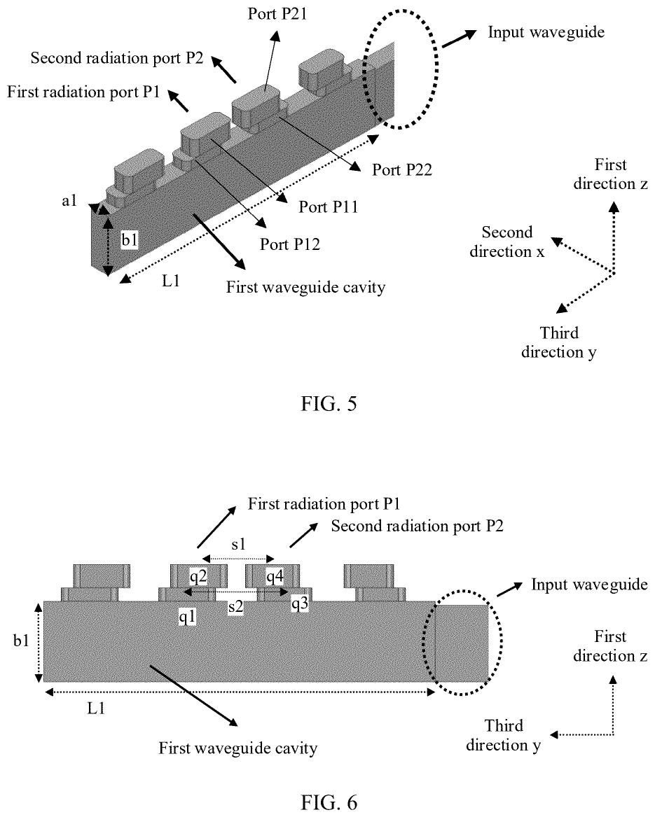

FIG. 5 is a diagram of a structure of a waveguide apparatus according to an embodiment of this application.

As shown in FIG. 5, the waveguide apparatus includes: a first waveguide cavity, a first radiation port P1, and a second radiation port P2.

A signal in the first waveguide cavity is radiated through the first radiation port P1 and the second radiation port P2.

A spacing between a radiation end of the first radiation port P1 and a radiation end of the second radiation port P2 is less than a spacing between a connection end of the first radiation port P1, which is connected to the first waveguide cavity, and a connection end of the second radiation port P2, which is connected to the first waveguide cavity.

It may be understood that the waveguide apparatus shown in FIG. 5 includes four radiation ports, which is merely used as a possible example for description. The waveguide apparatus may further include more or fewer radiation ports. This is not limited in embodiments of this application. For brevity and convenience of description, the first radiation port P1 and the second radiation port P2 are used as an example for description in this embodiment of this application. Therefore, this embodiment of this application should not be limited thereto. In the waveguide apparatus, the spacing between the radiation end of the first radiation port P1 and the radiation end of the second radiation port P2 is a first spacing, and the spacing between the connection end of the first radiation port P1, which is connected to the first waveguide cavity, and the connection end of the second radiation port P2, which is connected to the first waveguide cavity, is a second spacing. The first spacing is set to be less than the second spacing, so that a grating lobe of a waveguide antenna can be suppressed, to reduce a sidelobe level of the waveguide antenna.

It may be understood that the radiation end and the connection end are different parts into which the radiation port is divided based on relative proximity to the first waveguide cavity. Specifically, the radiation end may be an end that is of the radiation port and that is away from the first waveguide cavity, and the connection end may be an end that is of the radiation port and that is close to the first waveguide cavity. For example, for the first radiation port P1 in FIG. 5, one end that is of the radiation port and that is away from the first waveguide cavity is a port P11, that is, the radiation end of the first radiation port P1 is the port P11; and one end that is of the radiation port and that is close to the first waveguide cavity is a port P12, that is, the connection end of the first radiation port P1 is the port P12. For example, for the second radiation port P2 in FIG. 5, one end that is of the radiation port and that is away from the first waveguide cavity is a port P21, that is, the radiation end of the second radiation port P2 is the port P21; and one end that is of the radiation port and that is away from the first waveguide cavity is a port P22, that is, the connection end of the second radiation port P2 is the port P22. In an actual product structure, because the radiation port and the first waveguide cavity may be integrally formed, the connection end is a joint between a radiation part and the first waveguide cavity.

It may be understood that, in this embodiment of this application, the spacing between the first radiation port and the second radiation port gradually decreases in a direction in which a signal is radiated through the radiation port, namely, a first direction (z direction) in FIG. 5. A smaller spacing between the radiation ports can suppress the grating lobe of the waveguide antenna, to reduce the sidelobe level of the waveguide antenna.

It may be understood that the first direction (z direction), a second direction (an x direction), and a third direction (y direction) in FIG. 5 are perpendicular to each other to form a three-dimensional space. In this case, the first direction (z direction) is a direction in which the signal is radiated through the radiation port, the second direction (x direction) is a direction perpendicular to a wide side wall of the first waveguide cavity, and the third direction (y direction) is a direction parallel to the wide side wall of the first waveguide cavity.

In some embodiments, the waveguide apparatus may further include an input waveguide, used to input a signal into the first waveguide cavity. In some embodiments, the input waveguide may alternatively be a feed-in structure in another form, and is used to feed a signal into the first waveguide cavity. This is not limited in embodiments of this application.

In this embodiment of this application, the spacing between the radiation ends of the two radiation ports is set to be less than the spacing between the connection ends of the two radiation ports, connected to the waveguide cavity, so that a series-fed waveguide antenna with a low sidelobe level can be implemented.

Compared with the current parallel-fed waveguide antenna, the waveguide apparatus in this embodiment of this application uses a series-fed waveguide in a simpler feeding form, so that complexity of a three-dimensional structure of the waveguide antenna can be reduced, a requirement for machining precision can be lowered, and machining costs can be reduced. In addition, the spacing between the radiation ends of the two radiation ports is set to be less than the spacing between the connection ends, of the two radiation ports, connected to the waveguide cavity, so that a sidelobe level of the series-fed waveguide antenna can be reduced, and an advantage of the waveguide antenna in radiation transmission efficiency can be achieved.

In some embodiments, a low sidelobe level effect achieved in the series-fed waveguide antenna by reducing a spatial distance between radiation ports may be described with reference to a spacing between array elements in an antenna array and a sidelobe level principle. Details are as follows:

N radiation sources are arranged along a Z axis to form a straight line. It is assumed that elements are the same in amplitude, and a phase of a preceding element leads that of a following element by β (an array in which the elements are equal in amplitude and phase is referred to as a uniform array).

According to an antenna array pattern product theorem (total pattern=element factor×array factor), when the elements on the array are the same, the elements can be considered as point sources to calculate the array factor. From a 1^{st} element onwards, a phase of each element arriving at an observation point lags behind a phase of kd cos θ+β. The array factor is:

$$AF = 1 + {e}^{+ j ( kd cos θ + β )} + {e}^{+ j 2 ( kd cos θ + β )} + … + {e}^{+ j ( N - 1 ) ( kd cos θ + β )} = {\sum }_{n = 1}^{N} {e}^{j ( n - 1 ) ( kd cos θ + β )} = {\sum }_{n = 1}^{N} {e}^{j ( n - 1 ) ψ} , ψ = kd cos θ + β .$$

The foregoing formula is a geometric progression, and according to a summation formula of the geometric progression, the following may be obtained:

$$AF = [ \frac{{e}^{j N ψ} - 1}{{e}^{j ψ} - 1} ] = {e}^{j [ ( N - 1 ) / 2 ] ψ} [ \frac{{e}^{j ( N / 2 ) ψ} - {e}^{- j ( N / 2 ) ψ}}{{e}^{j ( 1 / 2 ) ψ} - {e}^{- j ( 1 / 2 ) ψ}} ] = {e}^{j [ ( N - 1 ) / 2 ] ψ} [ \frac{sin ( \frac{N}{2} ψ )}{sin ( \frac{1}{2} ψ )} ] .$$

It is specified that a center of the array is an origin. Then, the foregoing formula may be simplified as follows:

$$AF = \frac{sin ( \frac{N}{2} ψ )}{sin ( \frac{1}{2} ψ )} .$$

When ψ approaches 0, the L'Hôpital's rule is applied to the foregoing formula, to obtain a limit:

$${lim}_{ψ \to 0} = \frac{sin ( \frac{N}{2} ψ )}{sin ( \frac{1}{2} ψ )} N .$$

That is, if a maximum value of AF is about N, a normalized array factor is:

$$A {F}_{n} = \frac{sin ( \frac{N}{2} ψ )}{N sin ( \frac{1}{2} ψ )} .$$

When ψ is small or N is large enough, the foregoing formula may be simplified as follows:

$$A {F}_{n} \approx \frac{sin ( \frac{N}{2} ψ )}{\frac{N}{2} ψ} .$$

Based on different values of ψ=kd cos θ+B, kd, and β, different types of array patterns can be implemented: (1) a broadside array, indicating that a maximum radiation direction is perpendicular to an axis of an array (an axis along which the array is arranged), where θₘ=90 deg; (2) an end-fire array, indicating that a maximum radiation direction is perpendicular to an axis of an array, where θₘ=0/180 deg; and (3) a phased array, indicating that a maximum radiation direction varies with time.

In this embodiment of this application, a one-dimensional antenna array is a broadside array, and an array factor expression shows that a main lobe of the array always appears at kd cos θ+B=0.

For the broadside array, θₘ=90 deg. It may be obtained through calculation:

$$β = - kd cos {θ}_{m} = 0 .$$

It can be learned from the foregoing formula that a phase difference between array elements is 0, that is, the array is an equal-amplitude and in-phase array. An array spacing d may be any distance that is not an integer multiple of a wavelength. When d=nλ, ψ=kd cos θ=+2nπ cos θ. Therefore, when θ=0° or 180°, AFₙ also has a maximum value, that is, a grating lobe (the grating lobe is one of side lobes). These grating lobe channels need to be avoided. Therefore, a maximum spacing dₘₐₓ between array elements is usually less than one wavelength.

Therefore, the spatial distance between the radiation ports is reduced, so that an effect of reducing the sidelobe level of the series-fed waveguide antenna can be achieved.

FIG. 6 is a plane diagram of a waveguide apparatus according to an embodiment of this application. It may be understood that the waveguide apparatus shown in FIG. 6 may be implemented as an independent embodiment; or the waveguide apparatus shown in FIG. 6 may be understood as a variation or supplement of the waveguide apparatus in FIG. 5. In this case, FIG. 6 may be understood as a plane view of the waveguide apparatus shown in FIG. 5 in a second direction (an x direction).

As shown in FIG. 6, the waveguide apparatus includes: a first waveguide cavity, a first radiation port P1, and a second radiation port P2.

A signal in the first waveguide cavity is radiated through the first radiation port P1 and the second radiation port P2.

A spacing between a radiation end of the first radiation port P1 and a radiation end of the second radiation port P2 is less than a spacing between a connection end, of the first radiation port P1, connected to the first waveguide cavity and a connection end, of the second radiation port P2, connected to the first waveguide cavity.

It may be understood that the waveguide apparatus shown in FIG. 6 includes four radiation ports, which is merely used as a possible example for description. The waveguide apparatus may further include more or fewer radiation ports. This is not limited in embodiments of this application. For brevity and convenience of description, the first radiation port P1 and the second radiation port P2 are used as an example for description in this embodiment of this application. Therefore, this embodiment of this application should not be limited thereto.

The first radiation port P1 includes a first radiation sub-segment q1 and a second radiation sub-segment q2 that are connected, and the second radiation port P2 includes a third radiation sub-segment q3 and a fourth radiation sub-segment q4 that are connected.

The first radiation sub-segment q1 and the third radiation sub-segment q3 are radiation segments close to the first waveguide cavity, and the second radiation sub-segment q2 and the fourth radiation sub-segment q4 are radiation segments away from the first waveguide cavity.

A spacing between the second radiation sub-segment q2 and the fourth radiation sub-segment q4 is less than a spacing between the first radiation sub-segment q1 and the third radiation sub-segment q3.

The foregoing radiation sub-segments are different parts into which the radiation ports are divided based on relative proximity to the first waveguide cavity. Specifically, the first radiation sub-segment q1 and the third radiation sub-segment q3 may be radiation segments close to the first waveguide cavity, and the second radiation sub-segment q2 and the fourth radiation sub-segment q4 may be radiation segments away from the first waveguide cavity. In addition, the spacing (namely, a spacing s1) between the second radiation sub-segment q2 and the fourth radiation sub-segment q4 is less than the spacing (namely, a spacing s2) between the first radiation sub-segment q1 and the third radiation sub-segment q3.

It may be understood that the radiation port in this embodiment of this application may include a plurality of (two or more) connected radiation sub-segments, and the plurality of connected radiation sub-segments need to meet the following condition: A spacing between radiation sub-segments that are of two radiation ports and that are away from the waveguide cavity is less than a spacing between radiation sub-segments that are of the two radiation ports and that are close to the waveguide cavity.

It may be understood that, in this embodiment of this application, a spacing between the radiation sub-segments of the two radiation ports gradually decreases in a direction in which a signal is radiated through the radiation port, namely, a first direction (z direction). A smaller spacing between the radiation ports can suppress the grating lobe of the waveguide antenna, to reduce the sidelobe level of the waveguide antenna.

It may be understood that the first direction (z direction) and a third direction (y direction) in FIG. 6 are perpendicular to each other, and a plane formed by the first direction (z direction) and the third direction (y direction) is perpendicular to a second direction (an x direction). In this case, the first direction (z direction) is a direction in which a signal is radiated through the radiation port, the second direction (x direction) is a direction perpendicular to a wide side wall of the first waveguide cavity, and the third direction (y direction) is a direction parallel to the wide side wall of the first waveguide cavity.

In some embodiments, the waveguide apparatus may further include an input waveguide, used to input a signal into the first waveguide cavity. In some embodiments, the input waveguide may alternatively be a feed-in structure in another form, and is used to feed a signal into the first waveguide cavity. This is not limited in embodiments of this application.

In this embodiment of this application, the spacing between the radiation ports decreases in the direction in which the signal is radiated, so that the grating lobe of the waveguide antenna can be suppressed, to reduce the sidelobe level of the waveguide antenna, and implement a series-fed waveguide antenna with a low sidelobe level. This can reduce complexity of a three-dimensional structure of the waveguide antenna, lower a requirement for machining precision, and reduce machining costs.

In a possible embodiment, the waveguide apparatus shown in FIG. 5 or FIG. 6 further includes a third radiation port.

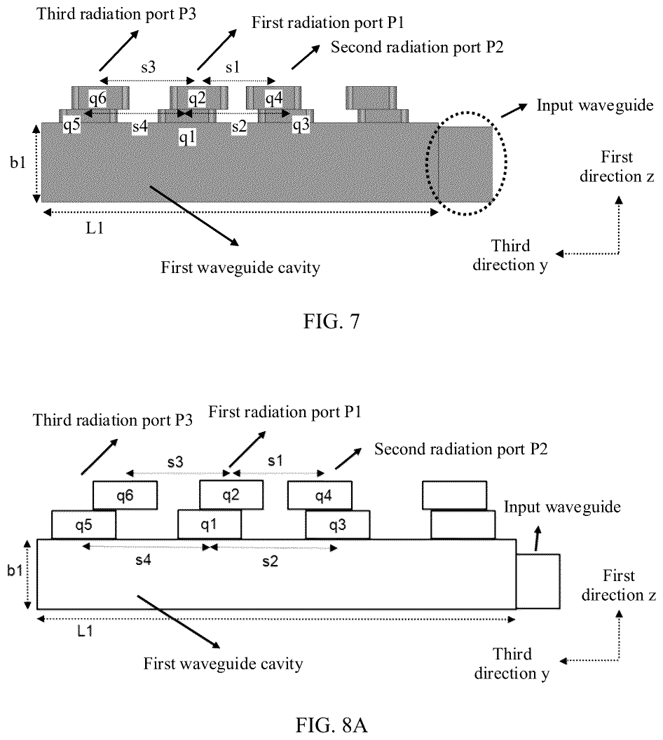

For details, refer to FIG. 7. FIG. 7 is a plane diagram of a waveguide apparatus according to an embodiment of this application. It may be understood that the waveguide apparatus shown in FIG. 7 may be implemented as an independent embodiment; or the waveguide apparatus shown in FIG. 7 may be understood as a variation or supplement of the waveguide apparatus in FIG. 5 or FIG. 6. In this case, FIG. 7 may be understood as a plane view of the waveguide apparatus shown in FIG. 5 in a second direction (an x direction).

As shown in FIG. 7, the waveguide apparatus further includes: a third radiation port P3.

A first radiation port P1 is located between a second radiation port P2 and the third radiation port P3.

A signal in a first waveguide cavity is further radiated through the third radiation port P3.

A spacing between a radiation end of the third radiation port P3 and a radiation end of the first radiation port P1 is less than or equal to a spacing between a connection end, of the third radiation port P3, connected to the first waveguide cavity and a connection end, of the first radiation port P1, connected to the first waveguide cavity; or a spacing between a radiation end of the third radiation port P3 and a radiation end of the first radiation port P1 is greater than a spacing between a connection end, of the third radiation port P3, connected to the first waveguide cavity and a connection end, of the first radiation port P1, connected to the first waveguide cavity.

It may be understood that the waveguide apparatus shown in FIG. 7 includes four radiation ports, which is merely used as a possible example for description. The waveguide apparatus may further include more or fewer radiation ports. This is not limited in embodiments of this application. For brevity and convenience of description, the first radiation port P1, the second radiation port P2, and the third radiation port P3 are used as an example for description in this embodiment of this application. Therefore, this embodiment of this application should not be limited thereto.

The first radiation port P1 and the second radiation port P2 are distributed closer to a center of a narrow side wall of the first waveguide cavity than the third radiation port P3. The spacing between the radiation end of the third radiation port P3 and the radiation end of the first radiation port P1 is a third spacing (namely, s3), and the spacing between the connection end, of the third radiation port P3, connected to the first waveguide cavity and the connection end, of the first radiation port P1, connected to the first waveguide cavity is a fourth spacing (namely, s4). In this case, regardless of whether the third spacing (s3) is less than, equal to, or greater than the fourth spacing (s4), a grating lobe of the waveguide antenna can be suppressed to some extent, to reduce a sidelobe level of the waveguide antenna.

It may be understood that the radiation end and the connection end are different parts into which the radiation ports are divided based on relative proximity to the first waveguide cavity. Specifically, the radiation end may be an end that is of the radiation port and that is away from the first waveguide cavity, and the connection end may be an end that is of the radiation port and that is close to the first waveguide cavity.

It may be understood that, in this embodiment of this application, regardless of whether the spacing between the third radiation port P3 and the first radiation port P1 gradually decreases, remains unchanged, or increases in a direction in which the signal is radiated through the radiation port, the grating lobe of the waveguide antenna can be suppressed to some extent, to reduce the sidelobe level of the waveguide antenna.

It may be understood that an effect of suppressing the grating lobe of the waveguide antenna in a case in which the third spacing (s3) is less than the fourth spacing (s4) is better than an effect of suppressing the grating lobe of the waveguide antenna in a case in which the third spacing (s3) is greater than the fourth spacing (s4), so that an effect of reducing the sidelobe level of the waveguide antenna is better. To be specific, an effect of suppressing the grating lobe of the waveguide antenna in a case in which the third spacing gradually decreases in the direction in which the signal is radiated through the radiation port is better than an effect of suppressing the grating lobe of the waveguide antenna in a case in which the fourth spacing gradually increases in the direction in which the signal is radiated through the radiation port, so that the effect of reducing the sidelobe level of the waveguide antenna is better.

It may be understood that a first direction (z direction) and a third direction (y direction) in FIG. 7 are perpendicular to each other, and a plane formed by the first direction (z direction) and the third direction (y direction) is perpendicular to a second direction (an x direction). In this case, the first direction (z direction) is a direction in which a signal is radiated through the radiation port, the second direction (x direction) is a direction perpendicular to a wide side wall of the first waveguide cavity, and the third direction (y direction) is a direction parallel to the wide side wall of the first waveguide cavity.

In some embodiments, the waveguide apparatus may further include an input waveguide, used to input a signal into the first waveguide cavity. In some embodiments, the input waveguide may alternatively be a feed-in structure in another form, and is used to feed a signal into the first waveguide cavity. This is not limited in embodiments of this application.

Further, the third radiation port P3 includes a fifth radiation sub-segment q5 and a sixth radiation sub-segment q6 that are connected.

The fifth radiation sub-segment q5 is a radiation segment close to the first waveguide cavity, and the sixth radiation sub-segment q6 is a radiation segment away from the first waveguide cavity.

A spacing between the sixth radiation sub-segment q6 and a second radiation sub-segment q2 is less than or equal to a spacing between the fifth radiation sub-segment q5 and a first radiation sub-segment q1; or a spacing between the sixth radiation sub-segment q6 and a second radiation sub-segment q2 is greater than a spacing between the fifth radiation sub-segment q5 and a first radiation sub-segment q1.

The foregoing radiation sub-segments are different parts into which the radiation ports are divided based on relative proximity to the first waveguide cavity. Specifically, the fifth radiation sub-segment q5 may be a radiation segment close to the first waveguide cavity, and the sixth radiation sub-segment q6 may be a radiation segment away from the first waveguide cavity. In addition, the spacing (namely, a spacing s3) between the sixth radiation sub-segment q6 and the second radiation sub-segment q2 is less than, equal to, or greater than the spacing (namely, a spacing s4) between the fifth radiation sub-segment q5 and the first radiation sub-segment q1.

It may be understood that the third radiation port P3 and the first radiation port P1 in this embodiment of this application may include a plurality of (two or more) connected radiation sub-segments, and the plurality of connected radiation sub-segments need to meet the following condition: A spacing between radiation sub-segments that are of the third radiation port P3 and the first radiation port P1 and that are away from the waveguide cavity may be less than or equal to a spacing between radiation sub-segments that are of the two radiation ports and that are close to the waveguide cavity.

It may be understood that an effect of suppressing the grating lobe of the waveguide antenna in a case in which the spacing between the radiation sub-segments that are of the third radiation port P3 and the first radiation port P1 and that are away from the waveguide cavity is less than the spacing between the radiation sub-segments that are of the two radiation ports and that are close to the waveguide cavity, is better than an effect of suppressing the grating lobe of the waveguide antenna in a case in which the spacing between the radiation sub-segments that are of the third radiation port P3 and the first radiation port P1 and that are away from the waveguide cavity is greater than the spacing between the radiation sub-segments that are of the two radiation ports and that are close to the waveguide cavity.

In some embodiments, a spacing between the second radiation sub-segment q2 and the fourth radiation sub-segment q4 is less than a spacing between the second radiation sub-segment q2 and the sixth radiation sub-segment q6.

The first radiation port and the second radiation port are distributed on the narrow side wall of the first waveguide cavity, and is closer to the center of the narrow side wall of the first waveguide cavity than the third radiation port that is also located on the narrow side wall of the first waveguide cavity. Therefore, in this embodiment of this application, the spacing between the second radiation sub-segment and the fourth radiation sub-segment is set to be less than the spacing between the second radiation sub-segment and the sixth radiation sub-segment, so that the grating lobe of the waveguide antenna can be suppressed, to reduce the sidelobe level of the waveguide antenna.

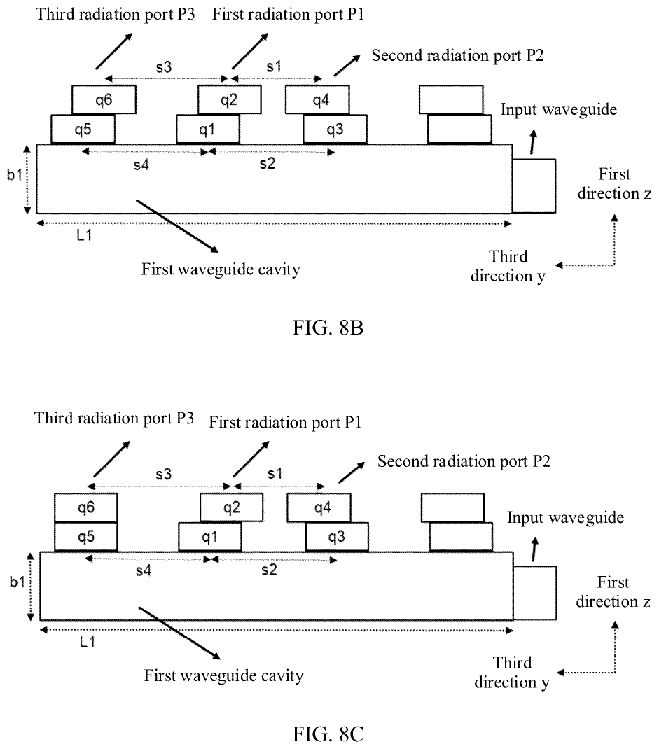

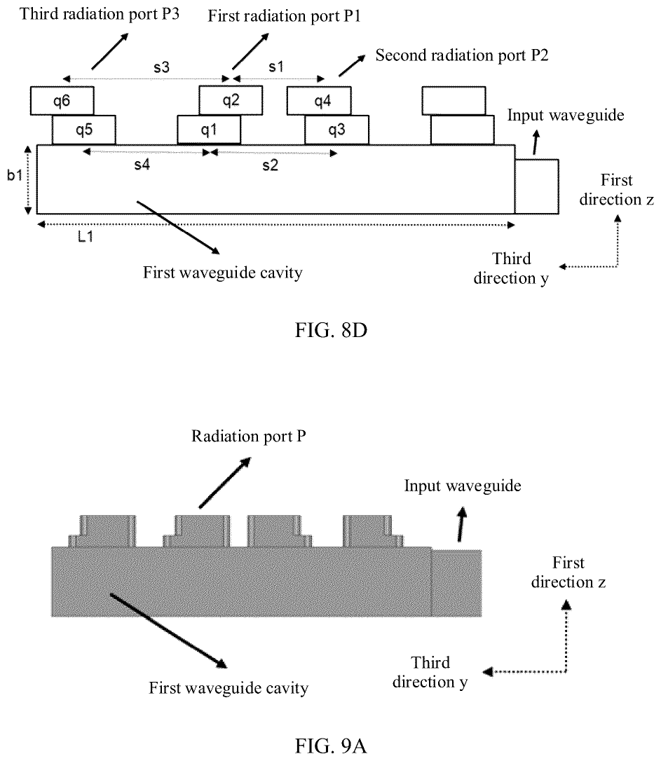

In addition, with reference to FIG. 8A to FIG. 8D, the following further describes a case in which the spacing between the sixth radiation sub-segment q6 and the second radiation sub-segment q2 is less than, equal to, or greater than the spacing between the fifth radiation sub-segment q5 and the first radiation sub-segment q1.

FIG. 8A to FIG. 8D are plane diagrams of a waveguide apparatus according to an embodiment of this application. It may be understood that the waveguide apparatus shown in FIG. 8A to FIG. 8D may be implemented as an independent embodiment; or the waveguide apparatus shown in FIG. 8A to FIG. 8D may be understood as a variation or supplement of the waveguide apparatus in FIG. 5, FIG. 6, or FIG. 7. In this case, FIG. 8A to FIG. 8D may be understood as plane views of the waveguide apparatus shown in FIG. 4 in a second direction (an x direction).

As shown in FIG. 8A to FIG. 8D, a relationship between a spacing between a sixth radiation sub-segment q6 and a second radiation sub-segment q2 and a spacing between a fifth radiation sub-segment q5 and a first radiation sub-segment q1 is as follows:

### Case 1:

As shown in FIG. 8A, a plurality of radiation ports are evenly distributed on a narrow side wall of a first waveguide cavity, including but not limited to a first radiation port P1, a second radiation port P2, and a third radiation port P3. The first radiation port P1 and the second radiation port P2 are distributed closer to a center of the narrow side wall of the first waveguide cavity than the third radiation port P3.

Locations of a first radiation sub-segment q1 in the first radiation port P1, a third radiation sub-segment q3 in the second radiation port P2, and a fifth radiation sub-segment q5 in the third radiation port P3 remain unchanged; a fourth radiation sub-segment q4 in the second radiation port P2 is shifted leftward by a specific distance in a third direction (y direction); a second radiation sub-segment q2 in the first radiation port P1 is shifted rightward by a distance i1 in the third direction (y direction); and a sixth radiation sub-segment q6 in the third radiation port P3 is shifted rightward by a distance i2 in the third direction (y direction).

When i1 is less than i2, a distance by which the sixth radiation sub-segment q6 in the third radiation port P3 is shifted rightward in the third direction (y direction) is greater than a distance by which the second radiation sub-segment q2 in the first radiation port P1 is shifted rightward in the third direction (y direction), so that a spacing (namely, a spacing s3) between the sixth radiation sub-segment q6 and the second radiation sub-segment q2 is less than a spacing (namely, a spacing s4) between the fifth radiation sub-segment q5 and the first radiation sub-segment q1. In this way, a grating lobe of a waveguide antenna can be suppressed, to reduce a sidelobe level of the waveguide antenna.

### Case 2:

As shown in FIG. 8B, a plurality of radiation ports are evenly distributed on a narrow side wall of a first waveguide cavity, including but not limited to a first radiation port P1, a second radiation port P2, and a third radiation port P3. The first radiation port P1 and the second radiation port P2 are distributed closer to a center of the narrow side wall of the first waveguide cavity than the third radiation port P3.

Locations of a first radiation sub-segment q1 in the first radiation port P1, a third radiation sub-segment q3 in the second radiation port P2, and a fifth radiation sub-segment q5 in the third radiation port P3 remain unchanged; a fourth radiation sub-segment q4 in the second radiation port P2 is shifted leftward by a specific distance in a third direction (y direction); a second radiation sub-segment q2 in the first radiation port P1 is shifted rightward by a distance i1 in the third direction (y direction); and a sixth radiation sub-segment q6 in the third radiation port P3 is shifted rightward by a distance i2 in the third direction (y direction), where i1 is less than i2.

When i1 is equal to i2, a distance by which the sixth radiation sub-segment q6 in the third radiation port P3 is shifted rightward in the third direction (y direction) is equal to a distance by which the second radiation sub-segment q2 in the first radiation port P1 is shifted rightward in the third direction (y direction), so that a spacing (namely, a spacing s3) between the sixth radiation sub-segment q6 and the second radiation sub-segment q2 is equal to a spacing (namely, a spacing s4) between the fifth radiation sub-segment q5 and the first radiation sub-segment q1.

In this case, because a spacing between the first radiation port P1 and the second radiation port P2 that are distributed closer to the center of the narrow side wall of the first waveguide cavity decreases in a first direction (z direction), a grating lobe of a waveguide antenna can still be suppressed to some extent, to reduce a sidelobe level of the waveguide antenna.

### Case 3:

As shown in FIG. 8C, a plurality of radiation ports are evenly distributed on a narrow side wall of a first waveguide cavity, including but not limited to a first radiation port P1, a second radiation port P2, and a third radiation port P3. The first radiation port P1 and the second radiation port P2 are distributed closer to a center of the narrow side wall of the first waveguide cavity than the third radiation port P3.

Locations of a first radiation sub-segment q1 in the first radiation port P1, a third radiation sub-segment q3 in the second radiation port P2, and a fifth radiation sub-segment q5 in the third radiation port P3 remain unchanged; a fourth radiation sub-segment q4 in the second radiation port P2 is shifted leftward by a specific distance in a third direction (y direction); a second radiation sub-segment q2 in the first radiation port P1 is shifted rightward by a distance i1 in the third direction (y direction); and a sixth radiation sub-segment q6 in the third radiation port P3 is shifted rightward by a distance i2 in the third direction (y direction), where i1 is less than i2.

When i1 is greater than i2, a distance by which the sixth radiation sub-segment q6 in the third radiation port P3 is shifted rightward in the third direction (y direction) is less than a distance by which the second radiation sub-segment q2 in the first radiation port P1 is shifted rightward in the third direction (y direction), so that a spacing (namely, a spacing s3) between the sixth radiation sub-segment q6 and the second radiation sub-segment q2 is greater than a spacing (namely, a spacing s4) between the fifth radiation sub-segment q5 and the first radiation sub-segment q1.

Particularly, when i1 is greater than i2 and i2 is 0, the sixth radiation sub-segment q6 in the third radiation port P3 is not shifted, and the spacing (namely, a spacing s3) between the sixth radiation sub-segment q6 and the second radiation sub-segment q2 is also greater than the spacing (namely, a spacing s4) between the fifth radiation sub-segment q5 and the first radiation sub-segment q1.

In this case, because a spacing between the first radiation port P1 and the second radiation port P2 that are distributed closer to the center of the narrow side wall of the first waveguide cavity decreases in a first direction (z direction), a grating lobe of a waveguide antenna can still be suppressed to some extent, to reduce a sidelobe level of the waveguide antenna.

### Case 4:

As shown in FIG. 8D, a plurality of radiation ports are evenly distributed on a narrow side wall of a first waveguide cavity, including but not limited to a first radiation port P1, a second radiation port P2, and a third radiation port P3. The first radiation port P1 and the second radiation port P2 are distributed closer to a center of the narrow side wall of the first waveguide cavity than the third radiation port P3.

Locations of a first radiation sub-segment q1 in the first radiation port P1, a third radiation sub-segment q3 in the second radiation port P2, and a fifth radiation sub-segment q5 in the third radiation port P3 remain unchanged; a fourth radiation sub-segment q4 in the second radiation port P2 is shifted leftward by a specific distance in a third direction (y direction); a second radiation sub-segment q2 in the first radiation port P1 is shifted rightward by a distance i1 in the third direction (y direction); and a sixth radiation sub-segment q6 in the third radiation port P3 is shifted leftward by a distance i2 in the third direction (y direction).

When i2 is greater than 0, a spacing (namely, a spacing s3) between the sixth radiation sub-segment q6 and the second radiation sub-segment q2 is greater than a spacing (namely, a spacing s4) between the fifth radiation sub-segment q5 and the first radiation sub-segment q1.

In this case, because a spacing between the first radiation port P1 and the second radiation port P2 that are distributed closer to the center of the narrow side wall of the first waveguide cavity decreases in a first direction (z direction), a grating lobe of a waveguide antenna can still be suppressed to some extent, to reduce a sidelobe level of the waveguide antenna.

It may be understood that, in the foregoing case 1 to case 4, effects of suppressing the grating lobe of the waveguide antenna and reducing the sidelobe level of the waveguide antenna are weakened sequentially, but the grating lobe of the waveguide antenna can be suppressed to some extent and the sidelobe level of the waveguide antenna can be reduced to some extent.

It may be understood that the foregoing four cases are merely used as several possible examples for description, and should not constitute a limitation on this embodiment of this application. Embodiments obtained based on a supplement or a proper variation of the foregoing example cases all fall within the protection scope of this application.

In a possible embodiment, in FIG. 6, FIG. 7, and FIG. 8A to FIG. 8D, the spacing s1 between the second radiation sub-segment q2 and the fourth radiation sub-segment q4 meets the following condition:

$$0.35 {λ}_{0} \leq s 1 \leq 0.6 {λ}_{0} ,$$

where λ₀ indicates a wavelength of an electromagnetic wave in vacuum.

For details, refer to FIG. 6, FIG. 7, and FIG. 8A to FIG. 8D. The spacing s1 between the second radiation sub-segment q2 and the fourth radiation sub-segment q4 meets the foregoing condition, so that the grating lobe of the waveguide antenna can be suppressed, to reduce the sidelobe level of the waveguide antenna.

In a possible embodiment, in FIG. 6, FIG. 7, and FIG. 8A to FIG. 8D, the spacing s2 between the first radiation sub-segment q1 and the third radiation sub-segment q3 meets the following condition:

$$0.4 {λ}_{g} \leq s 2 \leq 0.6 {λ}_{g} ,$$

where λ_{g} indicates a wavelength of an electromagnetic wave transmitted in the first waveguide cavity.

For details, refer to FIG. 6, FIG. 7, and FIG. 8A to FIG. 8D. The spacing s2 between the first radiation sub-segment q1 and the third radiation sub-segment q3 meets the foregoing condition, so that the grating lobe of the waveguide antenna can be suppressed, to reduce the sidelobe level of the waveguide antenna.

In a possible embodiment, in FIG. 5, the signal in the first waveguide cavity is radiated from the first radiation port P1 and the second radiation port P2 in the first direction through a first surface of the first waveguide cavity.

A width of the first surface in the second direction (x direction) is the same as a width of the radiation port, a length of the first surface in the third direction (y direction) is the same as a length of the first waveguide cavity, and the first direction (z direction), the second direction (x direction), and the third direction (y direction) are perpendicular to each other.

Specifically, as shown in FIG. 5, the first radiation port P1 and the second radiation port P2 are distributed on the narrow side wall of the first waveguide cavity (namely, the first surface of the first waveguide cavity). In this case, the signal in the first waveguide cavity is radiated from the first radiation port P1 and the second radiation port P2 in the first direction (z direction) through the first surface of the first waveguide cavity. It may be understood that the first direction (z direction), the second direction (x direction), and the third direction (y direction) are perpendicular to each other to form a three-dimensional space.

In this embodiment of this application, the first radiation port P1 and the second radiation port P2 are distributed on the narrow side wall of the first waveguide cavity, and the signal in the first waveguide cavity is radiated from the first radiation port P1 and the second radiation port P2 in the first direction (z direction) through the narrow side wall of the first waveguide cavity, so that signal radiation efficiency can be improved.

In a possible embodiment, in FIG. 5 to FIG. 7 and FIG. 8A to FIG. 8D, three-dimensional dimensions L1, a1, and b1 of the first waveguide cavity meet the following conditions:

$$0.85 \times ( N \times {λ}_{g} / 2 ) \leq L 1 \leq 1.15 \times ( N \times {λ}_{g} / 2 ) , 0 < a 1 \leq 0.5 {λ}_{g} , and$$

$$0.5 {λ}_{g} \leq b 1 \leq {λ}_{g} ,$$

where λ_{g} indicates the wavelength of the electromagnetic wave transmitted in the first waveguide cavity, and N indicates a quantity of radiation ports.

For details, refer to FIG. 5 to FIG. 7 and FIG. 8A to FIG. 8D. L1 indicates the length of the first waveguide cavity in the third direction (y direction), a1 indicates a width of the first waveguide cavity in the second direction (x direction), and b1 indicates a height of the first waveguide cavity in the first direction (z direction). The three-dimensional dimensions L1, a1, and b1 of the first waveguide cavity meet the foregoing conditions, so that steady-state field distribution in the first waveguide cavity can be implemented, and transmission efficiency of the signal in the first waveguide cavity is improved.

In some embodiments, the conditions that the dimensions a1, b1, and L1 of the first waveguide cavity meet are described with reference to a steady-state field distribution principle of the first waveguide cavity.

For the electromagnetic wave in the first waveguide cavity, rectangular components of the electromagnetic field satisfy the Helmholtz equation:

$$u ( x , y , z ) = X ( x ) Y ( y ) Z ( z ) ,$$

$${∇}^{2} u + {k}^{2} u = 0 , and$$

$${k}_{x}^{2} + {k}_{y}^{2} + {k}_{z}^{2} = {k}^{2} = {ω}^{2} ε μ .$$

According to metal boundary conditions, the following can be obtained:

$${E}_{x} = {A}_{1} cos {k}_{x} x sin {k}_{y} y sin {k}_{z} z ,$$

$${E}_{y} = {A}_{2} cos {k}_{y} y sin {k}_{x} x sin {k}_{z} z , and$$

$${E}_{z} = {A}_{3} cos {k}_{z} z sin {k}_{y} y sin {k}_{x} x .$$

According to boundary conditions of the dimensions a1, b1, and L1 of the first waveguide cavity, K×(a1, b1, and L1) needs to be an integer multiple of x, and the following is obtained:

$${k}_{x} = \frac{m π}{a 1} ,$$

$${k}_{y} = \frac{n π}{{L}_{1}} , and$$

$${k}_{z} = \frac{p π}{b 1} ,$$

where
m, n, p=0, 1, 2, 3, . . . ; and the foregoing three formulas are substituted into

$${k}_{x}^{2} + {k}_{y}^{2} + {k}_{z}^{2} = {k}^{2} = {ω}^{2} ε μ$$

to obtain a resonant frequency:

$${ω}_{mnp} = \frac{π}{\sqrt{ε μ}} \sqrt{{( \frac{m}{a 1} )}^{2} + {( \frac{n}{{L}_{1}} )}^{2} + {( \frac{p}{b 1} )}^{2}} , and$$

$${f}_{mnp} = \frac{1}{2 \sqrt{ε μ}} \sqrt{{( \frac{m}{a 1} )}^{2} + {( \frac{n}{{L}_{1}} )}^{2} + {( \frac{p}{b 1} )}^{2}} ,$$

where ωₘₙₚ indicates a local oscillation frequency of the first waveguide cavity, and fₘₙₚ indicates a resonant frequency of the first waveguide cavity.

When a lowest resonant frequency of the first waveguide cavity is m, n, p=1, 1, 0, then

$${f}_{110} = \frac{1}{2 \sqrt{ε μ}} \sqrt{{( \frac{1}{a 1} )}^{2} + {( \frac{1}{{L}_{1}} )}^{2}} .$$

A wavelength corresponding to the lowest resonant frequency is as follows:

$${λ}_{110} = \frac{2}{\sqrt{{( \frac{1}{a 1} )}^{2} + {( \frac{1}{{L}_{1}} )}^{2}}} .$$

In this embodiment of this application, it is assumed that the resonant frequency is 76.5 GHz, and m, n, p=1, 2*N−1, 0, where N indicates a quantity of radiation ports. In this way, the length L1 of the first waveguide cavity in the third direction (y direction) can be obtained through reverse solution.

In a possible embodiment, in FIG. 5 to FIG. 7 and FIG. 8A to FIG. 8D, a spacing d1 between two first waveguide cavities in the waveguide apparatus meets the following condition:

$$0.5 {λ}_{0} \leq d 1 \leq 1.5 {λ}_{0} ,$$

where λ₀ indicates the wavelength of the electromagnetic wave in vacuum.

In this embodiment of this application, the spacing d1 between the two (or more) first waveguide cavities in the waveguide apparatus meets the foregoing condition, so that a feed network can be simplified, and a waveguide antenna array can be arranged at a small spacing. This reduces complexity of the three-dimensional structure of the waveguide antenna, lowers the requirement for machining precision, and reduces the machining costs.

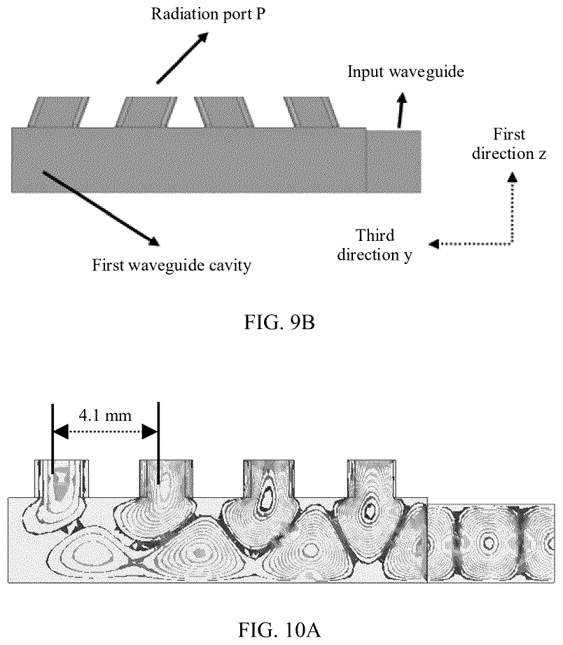

In a possible embodiment, in FIG. 5 to FIG. 7, FIG. 8A to FIG. 8D, FIG. 9A, and FIG. 9B, the first waveguide cavity has a bent structure, and the bent structure is used to connect the first radiation port to the second radiation port.

The bent structure may be a straight-line bent structure or a curve bent structure (for example, including but not limited to a triangular waveform, a sine waveform, and a cosine waveform). This is not limited in embodiments of this application.

In this embodiment of this application, after a straight waveguide is reconstructed into a waveguide having a bent structure, radiation ports are designed on a narrow side wall, so that a spatial distance between the radiation ports can be reduced within an entire waveguide wavelength, and the grating lobe of the waveguide antenna can be suppressed, to reduce the sidelobe level of the waveguide antenna and achieve an advantage of the waveguide antenna in radiation transmission efficiency.

Further, cross-sectional dimensions x1 and y1 of the bent structure in the first direction (z direction) meet the following conditions:

$$0.15 {λ}_{g} \leq x 1 \leq 0.35 {λ}_{g} and 0.65 {λ}_{g} \leq y 1 \leq 0.85 {λ}_{g} ,$$

where x1 indicates a length of the bent structure in the second direction (x direction), and y1 indicates a length of the bent structure in the third direction (y direction).

In this embodiment of this application, the cross-sectional dimensions x1 and y1 of the bent structure in the first direction (z direction) meet the foregoing conditions. In this way, a spatial distance between radiation ports can be reduced within an entire waveguide wavelength, and the grating lobe of the waveguide antenna can be suppressed, to reduce the sidelobe level of the waveguide antenna and achieve an advantage of the waveguide antenna in radiation transmission efficiency.

In some embodiments, to decrease a spacing between radiation ports in the waveguide apparatuses shown in FIG. 5 to FIG. 7 and FIG. 8A to FIG. 8D in a direction in which the signal is radiated, embodiments of this application further provide several waveguide apparatuses including radiation ports in other structural forms.

For details, refer to FIG. 9A and FIG. 9B. FIG. 9A and FIG. 9B are plane diagrams of a waveguide apparatus according to an embodiment of this application. It may be understood that, the waveguide apparatus shown in FIG. 9A and FIG. 9B may be implemented as an independent embodiment; or the waveguide apparatus shown in FIG. 9A and FIG. 9B may be understood as a variation or supplement of the waveguide apparatus in FIG. 5 to FIG. 7 and FIG. 8A to FIG. 8D. In this case, FIG. 9A and FIG. 9B may be understood as plane views after a proper variation of the waveguide apparatus shown in FIG. 4 in a second direction (an x direction).

As shown in FIG. 9A, a spacing between radiation ports in the waveguide apparatus decreases in a direction in which a signal is radiated, so that a grating lobe of a waveguide antenna can be suppressed, and a sidelobe level of the waveguide antenna can be reduced.

It may be understood that, different from a form and a structure of a radiation port in the waveguide apparatus in FIG. 5 to FIG. 7 and FIG. 8A to FIG. 8D, a length, of a radiation sub-segment that is close to the first waveguide cavity and that is of a radiation port in the waveguide apparatus in this embodiment of this application, in a third direction (y direction) is greater than a length, of a radiation sub-segment away from the first waveguide cavity, in the third direction (y direction).

As shown in FIG. 9B, a spacing between radiation ports in the waveguide apparatus decreases in a direction in which a signal is radiated, so that a grating lobe of a waveguide antenna can be suppressed, and a sidelobe level of the waveguide antenna can be reduced.

It may be understood that, different from the form and structure of the radiation port in the waveguide apparatus in FIG. 5 to FIG. 7, FIG. 8A to FIG. 8D, and FIG. 9A, a surface of the radiation port in the waveguide apparatus in this embodiment of this application is smooth, and it may be considered that the radiation port is differential into a plurality of connected radiation sub-segments, and these radiation sub-segments are smoothly connected to form a tilted radiation port.

In a possible embodiment, in FIG. 5 to FIG. 7, FIG. 8A to FIG. 8D, FIG. 9A, and FIG. 9B, a pattern sidelobe level corresponding to the waveguide apparatus is less than a first threshold.

The first threshold in this embodiment of this application is not a fixed value, and may be adjusted based on different application scenarios. For example, compared with a conventional PCB printed antenna, the waveguide apparatus in this embodiment of this application has a great advantage in radiation efficiency. In this case, the first threshold may be adjusted, so that the pattern sidelobe level corresponding to the waveguide apparatus is less than a pattern sidelobe level corresponding to the conventional PCB printed antenna.

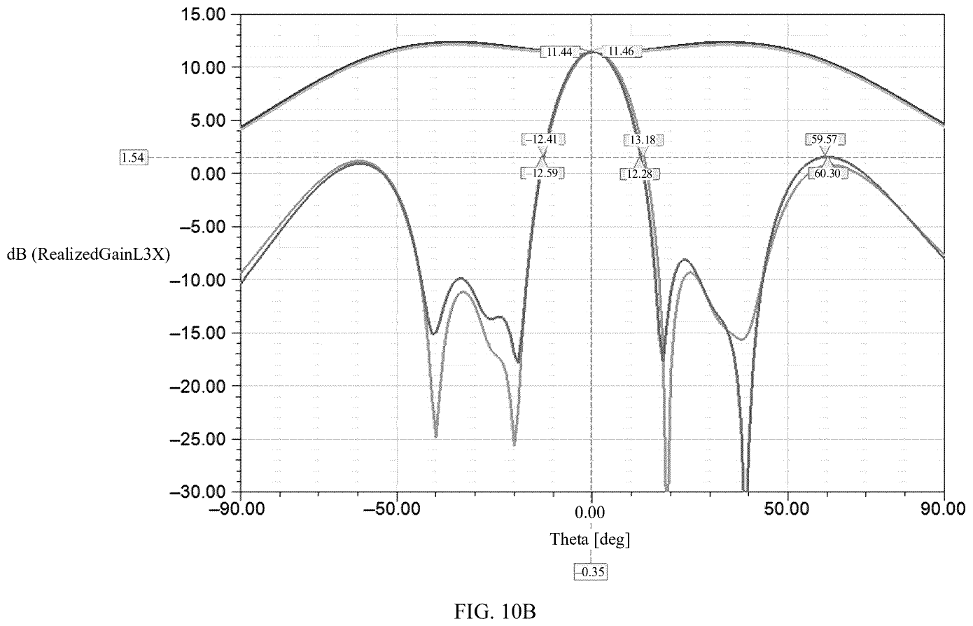

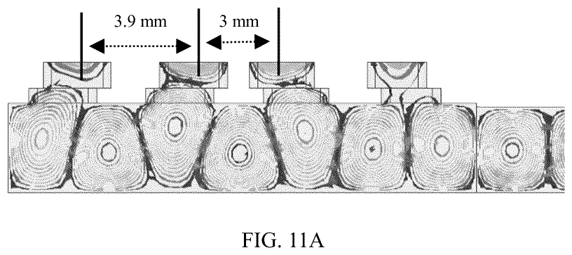

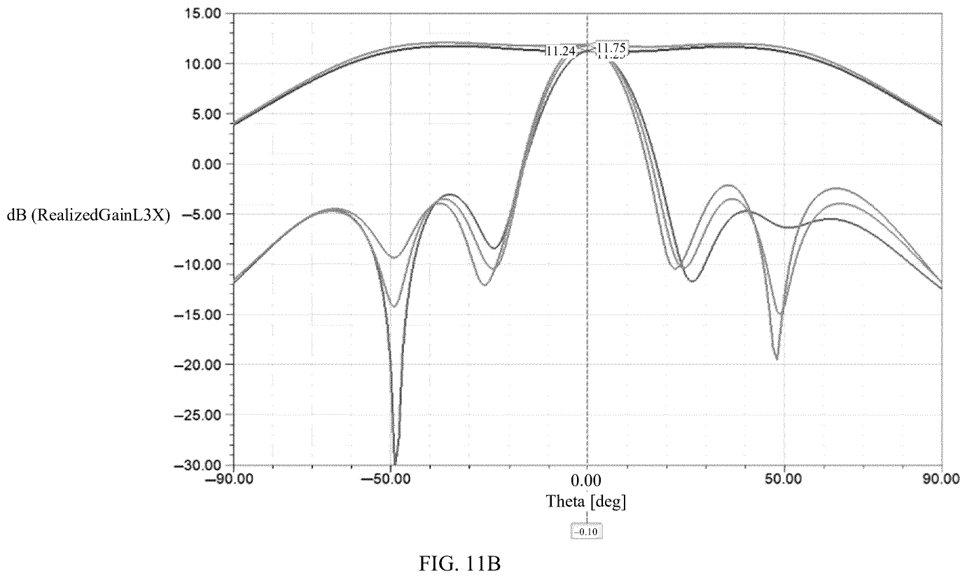

For details, refer to FIG. 10A, FIG. 10B, FIG. 11A, and FIG. 11B. FIG. 10A and FIG. 11A are diagrams of signal distribution of a waveguide apparatus according to an embodiment of this application. FIG. 10B and FIG. 11B are diagrams of effects of radiation patterns according to an embodiment of this application.

As shown in FIG. 10A and FIG. 11A, it can be learned that FIG. 10A shows signal distribution corresponding to the waveguide apparatus shown in FIG. 4, and FIG. 11A shows signal distribution corresponding to the waveguide apparatus shown in FIG. 5.

It can be learned from comparison between FIG. 10A and FIG. 11A that a spacing between radiation ends of two radiation ports is set to be less than a spacing between connection ends, of the two radiation ports, connected to the waveguide cavity, so that a sidelobe level of a series-fed waveguide antenna can be reduced, and an advantage of the waveguide antenna in radiation transmission efficiency can be achieved.

As shown in FIG. 10B and FIG. 11B, it can be learned that FIG. 10B is a radiation pattern corresponding to the waveguide apparatus shown in FIG. 4, and FIG. 11B is a radiation pattern corresponding to the waveguide apparatus shown in FIG. 5.

It can be learned from comparison between FIG. 10B and FIG. 11B that, after a spacing between radiation ends of two radiation ports is set to be less than a spacing between connection ends, of the two radiation ports, connected to the waveguide cavity, a normal gain of an antenna basically remains unchanged, but a V-plane pattern sidelobe level is improved from −10 dB to −14 dB, so that a sidelobe level of a series-fed waveguide antenna can be reduced, and an advantage of the waveguide antenna in radiation transmission efficiency can be achieved.

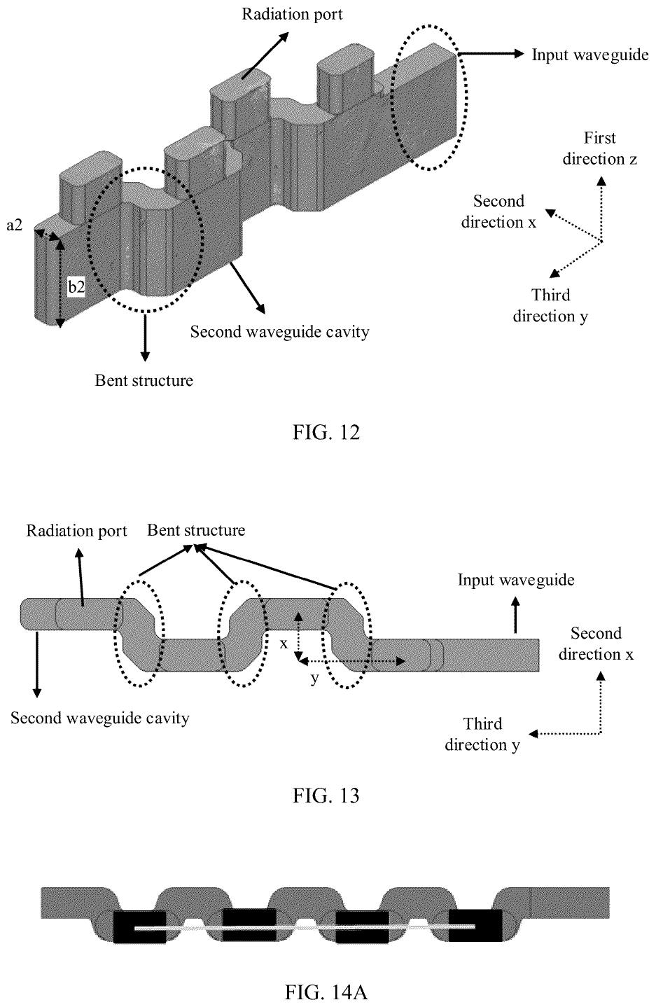

FIG. 12 is a diagram of a structure of a waveguide apparatus according to an embodiment of this application.

As shown in FIG. 12, the waveguide apparatus includes: a second waveguide cavity and M radiation ports, where M is an integer greater than 1; a signal in the second waveguide cavity is radiated through the M radiation ports; and the second waveguide cavity has a bent structure, and the bent structure is used to connect to the M radiation ports.

The bent structure may be a straight-line bent structure or a curve bent structure (for example, including but not limited to a triangular waveform, a sine waveform, and a cosine waveform). This is not limited in embodiments of this application.

It may be understood that the waveguide apparatus shown in FIG. 12 includes four radiation ports, which is merely used as a possible example for description. The waveguide apparatus may further include more or fewer radiation ports. This is not limited in embodiments of this application.

It may be understood that, in this embodiment of this application, the bent structure used to connect to the M radiation ports can reduce a spatial distance between the radiation ports within an entire waveguide wavelength, and suppress a grating lobe of the waveguide antenna, to reduce a sidelobe level of the waveguide antenna.

It may be understood that a first direction (z direction), a second direction (an x direction), and a third direction (y direction) in FIG. 12 are perpendicular to each other to form a three-dimensional space. In this case, the first direction (z direction) is a direction in which a signal is radiated through the radiation port, the second direction (x direction) is a direction perpendicular to a wide side wall of the second waveguide cavity, and the third direction (y direction) is a direction parallel to the wide side wall of the second waveguide cavity.

In some embodiments, the waveguide apparatus may further include an input waveguide, used to input a signal into the first waveguide cavity. In some embodiments, the input waveguide may alternatively be a feed-in structure in another form, and is used to feed a signal into the first waveguide cavity. This is not limited in embodiments of this application.

In this embodiment of this application, after a straight waveguide is reconstructed into a waveguide having a bent structure, radiation ports are designed on a narrow side wall, so that a spatial distance between the radiation ports can be reduced within an entire waveguide wavelength, and the grating lobe of the waveguide antenna can be suppressed, to reduce the sidelobe level of the waveguide antenna and achieve an advantage of the waveguide antenna in radiation transmission efficiency. Therefore, a series-fed waveguide antenna with a low sidelobe level is implemented.

Compared with the current parallel-fed waveguide antenna, the waveguide apparatus in this embodiment of this application uses a series-fed waveguide in a simpler feeding form, so that complexity of a three-dimensional structure of the waveguide antenna can be reduced, a requirement for machining precision can be lowered, and machining costs can be reduced. In addition, a sidelobe level of the series-fed waveguide antenna is reduced, so that an advantage of the waveguide antenna in radiation transmission efficiency can be achieved.

In some embodiments, a low sidelobe level effect achieved in the series-fed waveguide antenna by reducing a spatial distance between radiation ports may be described with reference to a spacing between array elements in an antenna array and a sidelobe level principle. For details, refer to descriptions of a spacing between array elements in an antenna array and a sidelobe level principle of the waveguide apparatus in FIG. 5. Details are not described herein again.

For details, refer to FIG. 13. FIG. 13 is a plane diagram of a waveguide apparatus according to an embodiment of this application. It may be understood that the waveguide apparatus shown in FIG. 13 may be implemented as an independent embodiment; or the waveguide apparatus shown in FIG. 13 may be understood as a variation or supplement of the waveguide apparatus in FIG. 12. In this case, FIG. 13 may be understood as a top view of the waveguide apparatus shown in FIG. 12 in a first direction (z direction).

As shown in FIG. 13, the waveguide apparatus includes: a second waveguide cavity and M radiation ports, where M is an integer greater than 1; a signal in the second waveguide cavity is radiated through the M radiation ports; and the second waveguide cavity has a bent structure, and the bent structure is used to connect to the M radiation ports.

The bent structure may be a straight-line bent structure or a curve bent structure (for example, including but not limited to a triangular waveform, a sine waveform, and a cosine waveform). This is not limited in embodiments of this application.

It may be understood that the waveguide apparatus shown in FIG. 13 includes four radiation ports, which is merely used as a possible example for description. The waveguide apparatus may further include more or fewer radiation ports. This is not limited in embodiments of this application.

It may be understood that, in this embodiment of this application, the bent structure used to connect to the M radiation ports can reduce a spatial distance between the radiation ports within an entire waveguide wavelength, and suppress a grating lobe of the waveguide antenna, to reduce a sidelobe level of the waveguide antenna.

In a possible embodiment, in FIG. 12 and FIG. 13, the signal in the second waveguide cavity is radiated from the M radiation ports in the first direction through a first surface of the second waveguide cavity.

A width of the first surface in a second direction (an x direction) is the same as a width of the radiation port, a length of the first surface in a third direction (y direction) is the same as a length of the second waveguide cavity, and the first direction (z direction), the second direction (x direction), and the third direction (y direction) are perpendicular to each other.

Specifically, as shown in FIG. 12 and FIG. 13, the M radiation ports are distributed on a narrow side wall of the second waveguide cavity (namely, the first surface of the second waveguide cavity). In this case, the signal in the second waveguide cavity is radiated from the M radiation ports in the first direction (z direction) through the first surface of the second waveguide cavity. It may be understood that the first direction (z direction), the second direction (x direction), and the third direction (y direction) are perpendicular to each other to form a three-dimensional space.

In this embodiment of this application, the M radiation ports are distributed on the narrow side wall of the second waveguide cavity, and the signal in the second waveguide cavity is radiated from the M radiation ports in the first direction through the narrow side wall of the second waveguide cavity, so that signal radiation efficiency can be improved.

In a possible embodiment, in FIG. 12 and FIG. 13, cross-sectional dimensions x2 and y2 of the bent structure in the first direction (z direction) meet the following conditions:

$$0.15 {λ}_{g} \leq x 2 \leq 0.35 {λ}_{g} and 0.65 {λ}_{g} \leq y 2 \leq 0.85 {λ}_{g} ,$$

where, as shown in FIG. 13, x2 indicates a length of the bent structure in the second direction (x direction), and y2 indicates a length of the bent structure in the third direction (y direction).

In this embodiment of this application, the cross-sectional dimensions x2 and y2 of the bent structure in the first direction (z direction) meet the foregoing conditions. In this way, a spatial distance between radiation ports can be reduced within an entire waveguide wavelength, and the grating lobe of the waveguide antenna can be suppressed, to reduce the sidelobe level of the waveguide antenna and achieve an advantage of the waveguide antenna in radiation transmission efficiency.

In a possible embodiment, in FIG. 12 and FIG. 13, three-dimensional dimensions L2, a2, and b2 of the second waveguide cavity meet the following conditions:

$$0.85 \times ( M \times {λ}_{g} / 2 ) \leq L 2 \leq 1.15 \times ( M \times {λ}_{g} / 2 ) , 0 < a 2 \leq 0.5 {λ}_{g} , and$$

$$0.5 {λ}_{g} \leq b 2 \leq {λ}_{g} ,$$

where λ_{g} indicates a wavelength of an electromagnetic wave transmitted in the second waveguide cavity; and, as shown in FIG. 12 and FIG. 13, L2 indicates the length of the second waveguide cavity in the third direction (y direction), a2 indicates a width of the second waveguide cavity in the second direction (x direction), and b2 indicates a height of the second waveguide cavity in the first direction (z direction). The three-dimensional dimensions L2, a2, and b2 of the second waveguide cavity meet the foregoing conditions, so that steady-state field distribution in the second waveguide cavity can be implemented, and transmission efficiency of the signal in the second waveguide cavity is improved.

In some embodiments, the conditions that the dimensions a2, b2, and L2 of the second waveguide cavity meet are described with reference to a steady-state field distribution principle of the second waveguide cavity. For details, refer to the foregoing descriptions of the steady-state field distribution principle of the first waveguide cavity. Details are not described herein again.

In a possible embodiment, in FIG. 12 and FIG. 13, a spacing s3 between two adjacent radiation ports in the M radiation ports meets the following condition:

$$0.35 {λ}_{0} \leq s 3 \leq 0.6 {λ}_{0} ,$$

where λ₀ indicates a wavelength of an electromagnetic wave in vacuum.

In this embodiment of this application, the spacing s3 between the two adjacent radiation ports in the M radiation ports meets the foregoing condition, so that the grating lobe of the waveguide antenna can be suppressed, to reduce the sidelobe level of the waveguide antenna.

In some embodiments, to reduce a spatial distance between radiation ports in the waveguide apparatuses shown in FIG. 12 and FIG. 13 within an entire waveguide wavelength, embodiments of this application further provide several waveguide apparatuses including waveguide cavities of other structures.

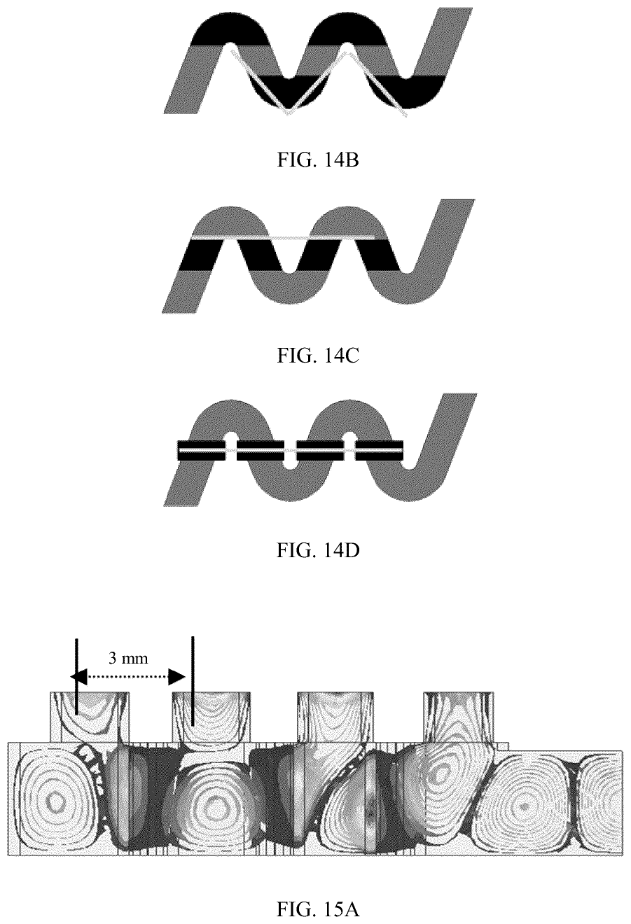

For details, refer to FIG. 14A to FIG. 14D (namely, FIG. 14A, FIG. 14B, FIG. 14C, and FIG. 14D). FIG. 14A to FIG. 14D are plane diagrams of a waveguide apparatus according to an embodiment of this application. It may be understood that the waveguide apparatus shown in FIG. 14A to FIG. 14D may be implemented as an independent embodiment; or the waveguide apparatus shown in FIG. 14A to FIG. 14D may be understood as a variation or supplement of the waveguide apparatus in FIG. 12 and FIG. 13. In this case, FIG. 14A to FIG. 14D may be understood as a top view of a proper variation of the waveguide apparatus shown in FIG. 12 in a first direction (z direction).

As shown in FIG. 14A to FIG. 14D, a bent structure used to connect a plurality of radiation ports can reduce a spatial distance between the radiation ports within an entire waveguide wavelength, and suppress a grating lobe of a waveguide antenna, to reduce a sidelobe level of the waveguide antenna and achieve an advantage of the waveguide antenna in radiation transmission efficiency.

It may be understood that, different from a form and a structure of the waveguide cavity of the waveguide apparatuses in FIG. 12 and FIG. 13, the waveguide cavity of the waveguide apparatus in this embodiment of this application includes a plurality of bent structures to reduce a spatial distance between radiation ports in an entire waveguide wavelength. The bent structure may be a straight-line bent structure or a curve bent structure (for example, including but not limited to a triangular waveform, a sine waveform, and a cosine waveform). This is not limited in embodiments of this application.

In a possible embodiment, in FIG. 12, FIG. 13, and FIG. 14A to FIG. 14D, a pattern sidelobe level corresponding to the waveguide apparatus is less than a second threshold.

The second threshold in this embodiment of this application is not a fixed value, and may be adjusted based on different application scenarios. For example, compared with a conventional PCB printed antenna, the waveguide apparatus in this embodiment of this application has great advantages in radiation efficiency. In this case, the second threshold may be adjusted, so that the pattern sidelobe level corresponding to the waveguide apparatus is less than a pattern sidelobe level corresponding to the conventional PCB printed antenna.

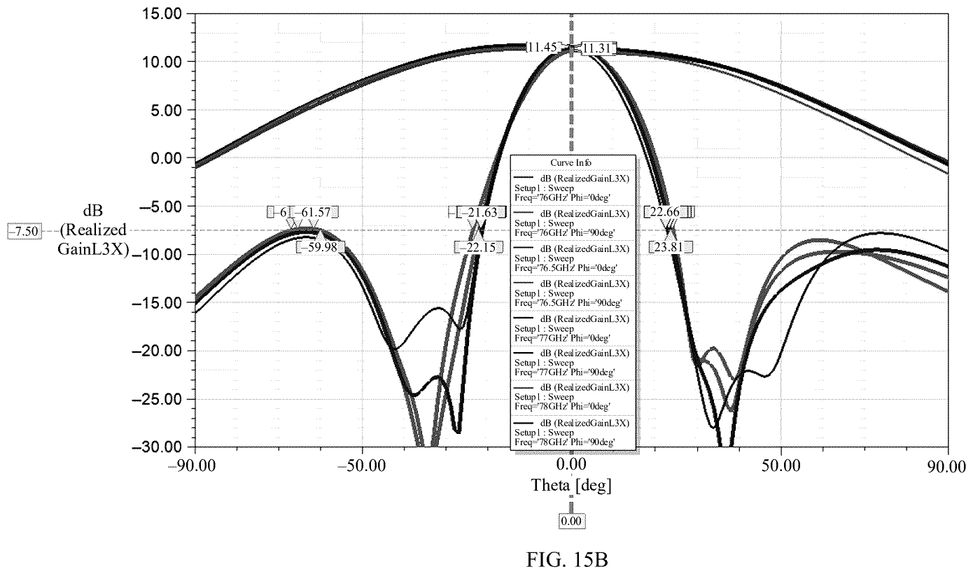

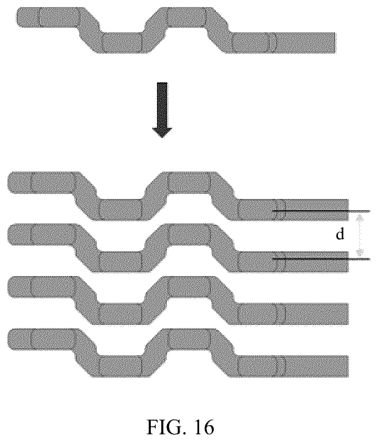

For details, refer to FIG. 15A and FIG. 15B. FIG. 15A is a diagram of signal distribution of a waveguide apparatus according to an embodiment of this application. FIG. 15B is a diagram of an effect of a radiation pattern according to an embodiment of this application.

As shown in FIG. 15A, it can be learned that FIG. 15A shows signal distribution corresponding to the waveguide apparatus shown in FIG. 12.

It can be learned from comparison between FIG. 15A and FIG. 10A that, after a straight waveguide is reconstructed into a waveguide having a bent structure, radiation ports are designed on a narrow side wall, so that a spatial distance between the radiation ports can be reduced within an entire waveguide wavelength, and the grating lobe of the waveguide antenna can be suppressed, to reduce the sidelobe level of the waveguide antenna and achieve an advantage of the waveguide antenna in radiation transmission efficiency.

As shown in FIG. 15B, it can be learned that FIG. 15B is a radiation pattern corresponding to the waveguide apparatus shown in FIG. 12.

It can be learned from comparison between FIG. 15B and FIG. 10B that, after a straight waveguide is reconstructed into a waveguide having a bent structure, radiation ports are designed on a narrow side wall, so that a spatial distance between the radiation ports can be reduced within an entire waveguide wavelength, a normal gain of the antenna basically remains unchanged, a V-plane pattern sidelobe level is improved from −10 dB to −19 dB, an improvement of 9 dB, the sidelobe level of the waveguide antenna can be reduced, and an advantage of the waveguide antenna in radiation transmission efficiency can be reduced.

In a possible embodiment, in FIG. 12, FIG. 13, and FIG. 14A to FIG. 14D, a spacing d2 between two second waveguide cavities in the waveguide apparatus meets the following condition:

$$0.5 {λ}_{0} \leq d 2 \leq 1.5 {λ}_{0} ,$$

where λ₀ indicates a wavelength of an electromagnetic wave in vacuum.

For details, refer to FIG. 16. FIG. 16 is a diagram of a waveguide antenna feed network according to an embodiment of this application.

As shown in FIG. 16, the waveguide apparatus includes four second waveguide cavities, and a spacing between two adjacent second waveguide cavities in the four second waveguide cavities meets the spacing d2, so that a feed network can be simplified, and a waveguide antenna array is arranged at a small spacing.

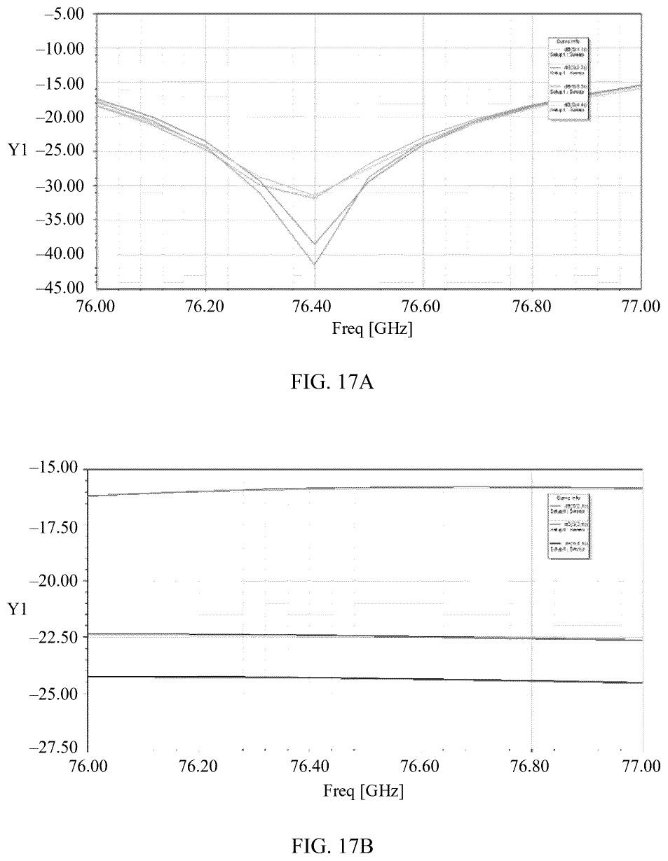

For example, when d2=0.5λ₀, for a return loss and a transmission isolation of the waveguide antenna feed network, refer to FIG. 17A and FIG. 17B. FIG. 17A is a diagram of an effect of a return loss according to an embodiment of this application. FIG. 17B is a diagram of an effect of transmission isolation according to an embodiment of this application.

It can be learned from FIG. 17A that a return loss SLL of the waveguide antenna feed network is less than or equal to 15 dB.

It can be learned from FIG. 17B that the transmission isolation Iso of the waveguide antenna feed network is less than or equal to 16 dB.

Therefore, a simplified direct-serial feeding manner makes it possible that antenna elements are arrayed in a wavelength of 0.5λ₀, and an impedance bandwidth and transmission isolation that meet requirements in an antenna array can be obtained.

In this embodiment of this application, the spacing d2 between the two (or more) second waveguide cavities in the waveguide apparatus meets the foregoing condition, so that a feed network can be simplified, and a waveguide antenna array can be arranged at a small spacing. This reduces complexity of a three-dimensional structure of the waveguide antenna, lowers a requirement for machining precision, and reduces machining costs.

In addition, in a possible embodiment, a method for preparing a waveguide apparatus is further provided. A procedure of the preparation method is as follows:

Method 1: A first waveguide cavity, a first radiation port, and a second radiation port may be obtained through plastic layered molding, a surface of each mould is then electroplated, and finally the waveguide apparatus including the first waveguide cavity, the first radiation port, and the second radiation port is obtained through layer brazing. Alternatively, a second waveguide cavity and M radiation ports may be obtained through plastic layered molding, a surface of each mould is then electroplated, and finally the waveguide apparatus including the second waveguide cavity and the M radiation ports is obtained through layer brazing.

A plastic layered molding process is as follows: Plastic is first heated and melted in the bottom of an injection molding machine, then pushed by a screw of the injection molding machine, enters a mold cavity through an injection nozzle of the injection molding machine and a casting system of a mold, and is cooled and hardened to obtain the product.

Plastic electroplating is to cover a plastic surface with a metal layer and give a metal property. A specific process includes surface cleaning, solvent treatment, conditioning treatment, and sensitivity treatment.

Brazing is a welding method in which solder, whose melting point is lower than a melting point of a weldment, and a weldment are simultaneously heated to a melting temperature of the solder, and a gap of a solid workpiece is filled with a liquid brazing material to connect metals. During brazing, an oxidation film and oil stains on a contact surface of a base metal should be removed first, so that a capillary tube can play a role after the brazing material melts, to increase wettability and capillary fluidity of the brazing material.

Method 2: A first waveguide cavity, a first radiation port, and a second radiation port may be machined in a layered manner, and then the first waveguide cavity, the first radiation port, and the second radiation port are formed by welding, to obtain the waveguide apparatus. Alternatively, a second waveguide cavity and M radiation ports may be machined in a layered manner, and then the second waveguide cavity and the M radiation ports are formed by welding, to obtain the waveguide apparatus.

The waveguide apparatus obtained by using the foregoing preparation method uses a series-fed waveguide in a simpler feeding form, so that complexity of a three-dimensional structure of a waveguide antenna can be reduced, a requirement for machining precision can be lowered, and machining costs can be reduced. In addition, a sidelobe level of a series-fed waveguide antenna is reduced, so that an advantage of the waveguide antenna in radiation transmission efficiency can be achieved.

For example, the waveguide apparatus shown in any one of FIG. 5 to FIG. 7, FIG. 8A to FIG. 8D, FIG. 9A and FIG. 9B, FIG. 12 and FIG. 13, FIG. 14A to FIG. 14D, and FIG. 16 may be obtained by using the foregoing method for preparing a waveguide apparatus. For structural features and functional features of the waveguide apparatus, refer to descriptions in FIG. 5 to FIG. 7, FIG. 8A and FIG. 8D, FIG. 9A and FIG. 9B, FIG. 12 and FIG. 13, FIG. 14A to FIG. 14D, and FIG. 16. Details are not described herein again.

This application provides a radar or a radar system. The radar or the radar system includes the waveguide apparatus provided in this application. It should be noted that there may be a smart sensor that is integrated with a plurality of sensors. When the smart sensor includes a millimeter-wave detection function, the smart sensor may also be referred to as a millimeter-wave radar or a millimeter-wave radar system.

This application provides a terminal device. The terminal device includes the waveguide apparatus provided in this application. For example, the terminal device may be a transportation tool, for example, a transportation means used in any possible scenario, for example, a vehicle, a truck, an aircraft, an uncrewed aerial vehicle, a slow transport vehicle, a spacecraft, or a ship, or may be any device that can carry a millimeter-wave detection apparatus, for example, a surveying and mapping device. One or more waveguide apparatuses provided in this application are deployed on the terminal device.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A waveguide apparatus, comprising:
a waveguide cavity, a first radiation port, and a second radiation port, wherein
a signal in the waveguide cavity is radiated through the first radiation port and the second radiation port; and
a spacing between a radiation end of the first radiation port and a radiation end of the second radiation port is less than a spacing between a connection end of the first radiation port and a connection end of the second radiation port, the connection end of the first radiation port and the connection end of the second radiation port both being connected to the waveguide cavity.

2. The waveguide apparatus according to claim 1, wherein
the first radiation port comprises a first radiation sub-segment and a second radiation sub-segment that are connected, and the second radiation port comprises a third radiation sub-segment and a fourth radiation sub-segment that are connected;
the first radiation sub-segment and the third radiation sub-segment are located closer to the waveguide cavity than the second radiation sub-segment and the fourth radiation sub-segment; and
a spacing between the second radiation sub-segment and the fourth radiation sub-segment is less than a spacing between the first radiation sub-segment and the third radiation sub-segment.

3. The waveguide apparatus according to claim 1, wherein the waveguide apparatus further comprises:
a third radiation port, wherein
the first radiation port is located between the second radiation port and the third radiation port;
the signal in the waveguide cavity is further radiated through the third radiation port; and
a spacing between a radiation end of the third radiation port and the radiation end of the first radiation port is less than or equal to a spacing between a connection end of the third radiation port and the connection end of the first radiation port, the connection end of the third radiation port being connected to the waveguide cavity.

4. The waveguide apparatus according to claim 3, wherein
the third radiation port comprises a fifth radiation sub-segment and a sixth radiation sub-segment that are connected;
the fifth radiation sub-segment is located closer to the waveguide cavity than the sixth radiation sub-segment; and
a spacing between the sixth radiation sub-segment and the second radiation sub-segment is less than or equal to a spacing between the fifth radiation sub-segment and the first radiation sub-segment.

5. The waveguide apparatus according to claim 4, wherein the spacing between a second radiation sub-segment and a fourth radiation sub-segment is less than the spacing between the sixth radiation sub-segment and the second radiation sub-segment.

6. The waveguide apparatus according to claim 2, wherein the spacing s1 between the second radiation sub-segment and the fourth radiation sub-segment meets the following condition:
0.35λ₀≤s1≤0.6λ₀, wherein λ₀ indicates a wavelength of an electromagnetic wave in vacuum.

7. The waveguide apparatus according to claim 2, wherein the spacing s2 between the first radiation sub-segment and the third radiation sub-segment meets the following condition:
0.4λ_{g}≤s2≤0.6λ_{g}, wherein λ_{g} indicates a wavelength of an electromagnetic wave transmitted in the waveguide cavity.

8. The waveguide apparatus according to claim 1, wherein:
the signal in the waveguide cavity is radiated from the first radiation port and the second radiation port in a first direction through a first surface of the waveguide cavity,
a width of the first surface in a second direction is the same as a width of the radiation port,
a length of the first surface in a third direction is the same as a length of the waveguide cavity, and
the first direction, the second direction, and the third direction are perpendicular to each other.

9. The waveguide apparatus according to claim 8, wherein three-dimensional dimensions L1, a1, and b1 of the waveguide cavity meet the following conditions:
$$0.85 \times ( N \times {λ}_{g} / 2 ) \leq L 1 \leq 1.15 \times ( N \times {λ}_{g} / 2 ) , 0 < a 1 \leq 0.5 {λ}_{g} , and$$
$$0.5 {λ}_{g} \leq b 1 \leq {λ}_{g} ,$$
wherein λ_{g} indicates a wavelength of an electromagnetic wave transmitted in the waveguide cavity, N indicates a quantity of radiation ports, and L1 indicates a length of the waveguide cavity in the third direction, a1 indicates a width of the waveguide cavity in the second direction, and b1 indicates a height of the waveguide cavity in the first direction.

10. The waveguide apparatus according to claim 1, wherein a spacing d1 between the waveguide cavity and another waveguide cavity in the waveguide apparatus meets the following condition:
0.5λ₀≤d1≤1.5λ₀, wherein λ₀ indicates a wavelength of the electromagnetic wave in vacuum.

11. The waveguide apparatus according to claim 1, wherein the waveguide cavity has a bent structure configured to connect the first radiation port to the second radiation port.

12. The waveguide apparatus according to claim 11, wherein cross-sectional dimensions x1 and y1 of the bent structure in a first direction meet the following conditions:
0.15λ_{g}≤x1≤0.35λ_{g} and 0.65λ_{g}≤y1≤0.85λ_{g}, wherein x1 indicates a length of the bent structure in a second direction, and y1 indicates a length of the bent structure in a third direction.

13. The waveguide apparatus according to claim 1, wherein a pattern sidelobe level corresponding to the waveguide apparatus is less than a first threshold.

14. A waveguide apparatus, comprising:
a waveguide cavity and M radiation ports, wherein
M is an integer greater than 1;
a signal in the waveguide cavity is radiated through the M radiation ports; and
the waveguide cavity has a bent structure configured to connect to the M radiation ports.

15. The waveguide apparatus according to claim 14, wherein: waveguide cavity
the signal in the waveguide cavity is radiated from the M radiation ports in a first direction through a first surface of the waveguide cavity,
a width of the first surface in a second direction is the same as a width of each radiation port,
a length of the first surface in a third direction is the same as a length of the waveguide cavity, and
the first direction, the second direction, and the third direction are perpendicular to each other.

16. The waveguide apparatus according to claim 15, wherein cross-sectional dimensions x2 and y2 of the bent structure in the first direction meet the following conditions:
0.15λ_{g}≤x2≤0.35λ_{g} and 0.65λ_{g}≤y2≤0.85λ_{g}, wherein x2 indicates a length of the bent structure in the second direction, and y2 indicates a length of the bent structure in the third direction.

17. The waveguide apparatus according to claim 15, wherein three-dimensional dimensions L2, a2, and b2 of the waveguide cavity meet the following conditions:
$$0.85 \times ( M \times {λ}_{g} / 2 ) \leq L 2 \leq 1.15 \times ( M \times {λ}_{g} / 2 ) , 0 < a 2 \leq 0.5 {λ}_{g} , and$$
$$0.5 {λ}_{g} \leq b 2 \leq {λ}_{g} ,$$
wherein
λ_{g} indicates a wavelength of an electromagnetic wave transmitted in the waveguide cavity; and
L2 indicates the length of the waveguide cavity in the third direction, a2 indicates a width of the waveguide cavity in the second direction, and b2 indicates a height of the waveguide cavity in the first direction.

18. The waveguide apparatus according to claim 14, wherein a spacing d2 between the waveguide cavity and another waveguide cavity in the waveguide apparatus meets the following condition:
0.5λ₀≤d2≤1.5λ₀, wherein λ₀ indicates a wavelength of an electromagnetic wave in vacuum.

19. The waveguide apparatus according to claim 14, wherein a spacing s3 between two adjacent radiation ports in the M radiation ports meets the following condition:
0.35λ₀≤s3≤0.6λ₀, wherein λ₀ indicates a wavelength of an electromagnetic wave in vacuum.

20. A radar comprising:
a first waveguide apparatus,
wherein the first waveguide apparatus comprises a first waveguide cavity, a first radiation port, and a second radiation port,
wherein, in the first waveguide apparatus:
a signal in the first waveguide cavity is radiated through the first radiation port and the second radiation port; and
a spacing between a radiation end of the first radiation port and a radiation end of the second radiation port is less than a spacing between a connection end of the first radiation port and a connection end of the second radiation port, the connection end of the first radiation port and the connection end of the second radiation port both being connected to the first waveguide cavity,
or a second waveguide apparatus,
wherein the second waveguide apparatus comprises a second waveguide cavity and M radiation ports, wherein M is an integer greater than 1,
wherein, in the second waveguide apparatus:
a signal in the second waveguide cavity is radiated through the M radiation ports; and
the second waveguide cavity has a bent structure, and the bent structure is used to connect to the M radiation ports.
